(19) United States
(12) Patent Application Publication
(10) Pub. No.: US 2017/0343360 A1
(43) Pub. Date: Nov. 30, 2017

(54) METHOD AND SYSTEM FOR MANAGING NAVIGATION AND TRACKING OF, FOR AND BY PORTABLE AND WEARABLE COMPUTING AND COMMUNICATIONS DEVICES

(71) Applicants: HIMA HARIKRISHNAN, BANGALORE (IN); SUNITA BHAGWAT, PUNE (IN); SHWETA THANDAVESWARAN, PUNE (IN); CHANDU MOHAN, ERNAKULAM (IN)

(72) Inventors: HIMA HARIKRISHNAN, BANGALORE (IN); SUNITA BHAGWAT, PUNE (IN); SHWETA THANDAVESWARAN, PUNE (IN); CHANDU MOHAN, ERNAKULAM (IN)

(21) Appl. No.: 15/594,619

(22) Filed: May 14, 2017

Related U.S. Application Data
(60) Provisional application No. 62/343,785, filed on May 31, 2016.

(51) Int. Cl. G01C 21/28; H04L 29/12; G01C 21/36; G01C 21/34; H04L 29/08; G06Q 20/12; G01S 19/42; G01S 19/12

(52) U.S. Cl. CPC G01C 21/28; H04L 67/12; H04L 61/203; G06Q 20/127; G01C 21/3655; G01C 21/3476; G01C 21/343; G01C 21/3644; G01C 21/3641; G01C 21/362; G01C 21/3484; G01S 19/12; G01S 19/428

(57) ABSTRACT

Embodiments of the present invention relate to route navigation and tracking systems, and methods thereof, and more particularly, to method and system for managing adaptive, dynamic, domain and platform-agnostic navigation and tracking of portable computing and communications devices, thereby facilitating generation of at least one of contextual, configurable notifications, and combinations thereof, for instance at least one of adaptively and dynamically configurable contextual notifications as well as alerts.

### BACKGROUND OF THE INVENTION

### Field of the Invention

Embodiments of the present invention relate to route navigation and tracking systems, and methods thereof, and more particularly, to method and system for managing navigation and tracking of, for and by portable and wearable computing and communications devices, thereby facilitating generation of at least one of contextual, configurable notifications as well as alerts, and combinations thereof.

### Description of the Related Art

A number of systems and methods are available for aiding users in navigation and route tracking. Such navigation and route tracking systems and methods use at least one of portable and embedded computing and communications devices containing Global Positioning Systems (GPS) to define the location of one or more target (or trackee) devices, whilst facilitating other mobile devices (tracker) to track the target devices. However, the existing navigation and route tracking systems and methods fail to: 1) provide multiple user options facilitating at least one of contextualizing and configuring notifications and alerts based on the position of the targets relative to the tracker devices for the user of tracker devices; 2) navigate of at least one of moving and stationary target devices using the tracker devices, and 3) create awareness of the safety indices of one or more areas or routes-of-interest. Thus, there is still a need for the design and implementation of a method and system for adaptively and dynamically managing domain and platform-agnostic navigation and tracking of targets by trackers and navigators, thereby facilitating managing 1) uncertainty or ambiguity of the whereabouts of one or more entities at least one of in transit and en-route and at least one of actively and passively involved in travel-detection-tracking-monitoring-related transactions, for instance persons, places or things, in at least one of Real-Time (RT) and Near Real-Time (NRT); 2) at least one of extended and deferred waiting period for at least one of pickups, drops and meetings; 3) at least one of known, unknown, expected, unexpected, natural, unnatural, wanted, unwanted, just, unjust, timely and untimely situations eventuating anytime, anywhere and anyhow, and at least one of panic and apprehensions therefor, upon at least one of traversal and presence of at least one of friend, colleague, family member and social media contact at least one of in transit, en-route and in standstill mode in potentially unsafe locations; 4) one or more distinct information or location sharing scenarios at least one of domain-, technology- and platform agnostically; 5) at least one of first-time, amateur, inexperienced, less frequent and route-agnostic travelers and tourists in safely reaching destinations; and 6) mutually tracking both trackers and targets in at least one of in transit and en-route.

### SUMMARY OF THE INVENTION

Embodiments of the present invention disclose a method for at least one of application domain- and platform-agnostically managing navigation and tracking of, for and by at least one of embedded and general-purpose, at least one of fixed, portable and wearable, computing and communications devices. The method comprises upon request by one or more of a first plurality of at least one of embedded and general-purpose, at least one of fixed, portable and wearable computing and communications devices belonging to at least one information provider client group serving as target devices, Authenticating, Authorizing and Accounting (AAA) each of the one or more target devices, using at least one information broker server, wherein the information broker server facilitates rendering at least one of context, location, safety, security, notification, alert management, and a combination thereof, as a service; upon successful Authentication, Authorization and Accounting (AAA), receiving from each of the one or more Authenticated, Authorized and Accounted (AAA) target devices at least one of contextual and locational information associated therewith, by the at least one information broker server; upon receiving, using each of the one or more AAA target devices for selectively generating a corresponding list of one or more of a second plurality of the aforementioned devices belonging to at least one information consumer client group serving as tracker-cum-navigator devices, wherein each of the one or more tracker-cum-navigator devices in each corresponding list for each of the corresponding one or more AAA target devices is preapproved thereby to access the at least one of contextual and location information associated therewith; storing and processing the at least one of contextual and locational information associated with each of the one or more AAA target devices, and corresponding selectively generated list in the at least one information broker server; upon request by the one or more of the tracker-cum-navigator devices to access the at least one of contextual and locational information associated with the corresponding one or more AAA targets, Authenticating, Authorizing and Accounting (AAA) each of the one or more tracker-cum-navigator devices, using the at least one information broker server; upon successful AAA, determining whether each of the one or more tracker-cum-navigator devices in each corresponding list for each of the corresponding one or more target devices is preapproved thereby to access the at least one of contextual and location information associated therewith, using the at least one information broker server; upon determination, granting access to the at least one of contextual and locational information associated with each of the one or more AAA target devices to the each of the one or more tracker-cum-navigator devices correspondingly preapproved thereby, using the at least one information broker server; upon accessing the at least one of contextual and locational information associated with the one or more AAA target devices, tracking and navigating to the each of the one or more AAA target devices at least one of in transit, en-route and in standstill mode based on the at least one of contextual and locational information associated therewith, using each of the correspondingly preapproved one or more tracker-cum-navigator devices at least one of in transit, en-route and in standstill mode; upon navigation and tracking, at least one of adaptively, dynamically generating, and a combination thereof, at least one of contextualizable, configurable, information, alerts and notifications, and a combination thereof, for each of the one or more AAA target devices, based on the at least one of contextual and locational information associated therewith, using each of the correspondingly preapproved one or more tracker-cum-navigator devices; and managing the generated at least one of contextually configurable information, alerts and notifications for each of the one or more AAA target devices via at least one of reconfiguring and re-contextualizing the same, and combination thereof, using each of the correspondingly preapproved one or more tracker-cum-navigator devices, thereby facilitating at least one of application domain-, technology- and platform-agnostic navigation and tracking of the AAA target devices by the AAA tracker-cum-navigator devices. These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagrammatic representation of a system facilitating adaptively and dynamically managing application domain- and platform-agnostic navigation and tracking of a first plurality of at least one of embedded and general-purpose, at least one of portable and wearable computing and communications devices serving as target devices using a second plurality of the aforementioned devices serving as tracker-cum-navigator devices, thereby facilitating generating at least one of contextual and configurable (or contextually configurable), information, notifications as well as alerts, and combinations thereof, according to one or more embodiments;

FIGS. 2A-C depicts a method for managing navigation and tracking of at least one of embedded and general-purpose, at least one of fixed, portable and wearable, computing and communications devices, according to one or more embodiments; and

FIG. 3 depicts a computer system that may be a computing device and may be utilized in various embodiments of the present invention.

While the method and system is described herein by way of example for several embodiments and illustrative drawings, those skilled in the art will recognize that the method and system for managing navigation and tracking of, for and by portable wearable computing and communications devices, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and system for managing navigation and tracking of, for and by portable wearable computing and communications devices defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of the present invention disclose methods and systems facilitating managing navigation and tracking of a first plurality of at least one of smart and retrofit smart, at least one of embedded and general-purpose, at least one of fixed, portable and wearable computing and communications devices serving as target devices using a second plurality of the at least one of embedded and general-purpose, at least one of portable and wearable computing and communications devices serving as tracker-cum-navigator devices. In the following detailed description, numerous specific details are set forth to provide a thorough understanding of claimed subject matter. However, it will be understood by those skilled in the art that claimed subject matter may be practiced without these specific details.

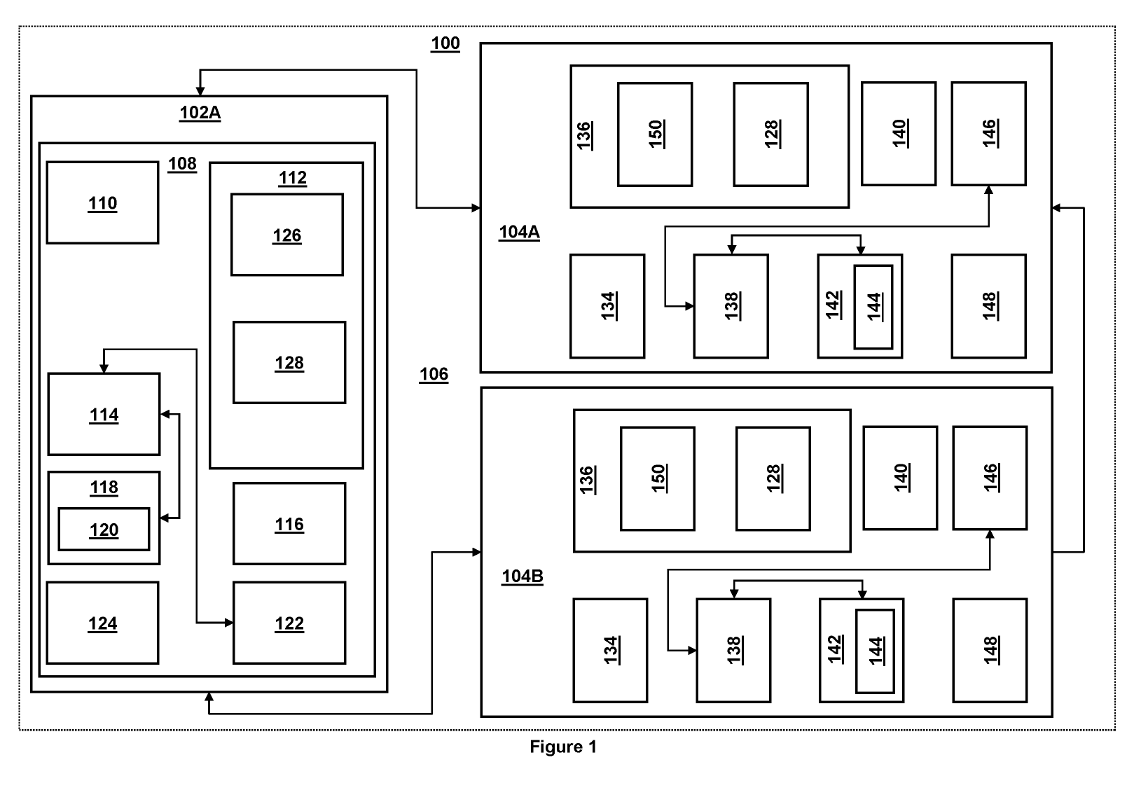

FIG. 1 depicts a block diagrammatic representation of a system facilitating adaptively and dynamically managing application domain- and platform-agnostic navigation and tracking of a first plurality of at least one of embedded and general-purpose, at least one of portable and wearable computing and communications devices serving as target devices using a second plurality of the aforementioned devices serving as tracker-cum-navigator devices, thereby facilitating generating at least one of contextual and configurable (or contextually configurable) information, notifications as well as alerts, and combinations thereof, according to one or more embodiments. In some simple embodiments, the system 100 may comprise at least one server subsystem 102, at least one client subsystem 104 and at least one network subsystem 106, wherein the server and client subsystems 102 and 104 (both not shown here explicitly) may be coupled through the network subsystem 106. In some practical embodiments, the system 100 may be based on cloud computing model. In some practical embodiments, the at least one client subsystem 104 may comprise at least one information provider client group 104A and at least one information consumer client group 104B, whereas the at least one server subsystem 102 may comprise at least one information broker server group 102A. As depicted in FIG. 1, in some limited embodiments, the at least one information provider client group 104A may comprise at least one information provider client (or target device) 104A, whereas the at least one information consumer client group 104B may comprise at least one information consumer client (or tracker-cum-navigator device) 104B, and whereas the at least one information broker server group 102A may comprise at least one information broker server 102A. In some practical embodiments, the system 100 may facilitate deployment of at least one of an application domain-, technology- and platform-agnostic tracker-cum-navigator device, for instance, in some simplified scenarios, the information consumer client 104B, thereby facilitating the tracker-cum-navigator device 104B in implementing a method for at least one of adaptively, dynamically generating, and a combination thereof, at least one of configurable contextual (or contextually configurable), context-based, context-dependent, context-sensitive, context-aware information, alerts, as well as notifications, in connection with a target device, for instance, in some simplified scenarios, the information provider client 104A, and managing the generated information, alerts and notifications via at least one of reconfiguring, re-contextualizing the same, and a combination thereof. For example, and in no way limiting the scope of the invention, in some limited embodiments, the tracker-cum-navigator device 104B may facilitate at least one of adaptively, dynamically generating, and a combination thereof, at least one of configurable locational, location-based, location-dependent, location-sensitive, location-aware information, alerts, as well as notifications.

In some potential embodiments, the system 100 may facilitate the tracker-cum-navigator devices 104B in implementing the method for at least one of adaptively, dynamically generating, and combination thereof, at least one of configurable contextual, context-based, context-dependent, context-sensitive and context-aware information, alerts, and notifications, in connection with the target devices 104A, and managing the generated information, alerts and notifications via at least one of reconfiguring, re-contextualizing the same, and combination thereof, based partly on at least one of the historical and current context of the target devices 104A, for example, and in no way limiting the scope of the invention, the location or position of the target device 104A relative to the tracker-cum-navigator device 104B. More specifically, in some exemplary embodiments, the system 100 may facilitate the tracker-cum-navigator devices 104B in implementing the method for at least one of adaptively, dynamically generating, and combination thereof, at least one of configurable contextual, context-based, context-dependent, context-sensitive and context-aware information, alerts and notifications, for the target devices 104A, and managing the generated information, alerts and notifications, based partly on the at least one of the historical and current context-of-presence, context-of-deployment, context-of-implementation, context-of-operation, context-of-event and context-of-use of the target devices 104A vis-à-vis, or from the viewpoint of, the tracker-cum-navigator devices 104B, in accordance with the principles of the present invention. Further, in some potential embodiments, the method may facilitate at least one of adaptively, dynamically generating, and combination thereof, at least one of configurable contextual, context-based, context-dependent, context-sensitive and context-aware information, alerts, and notifications, and managing the generated information, alerts and notifications, based partly on at least one of chronological, historical and current context-of-location, context-of-operation, context-of-travel, context-of-navigation, context-of-tracking, context-of-route, context-of-destination location, context-of-source location, context-of-deployment, context-of-event and context-of-use of, or associated with, the tracker-cum-navigator devices 104B vis-à-vis, or in view of, the target devices 104A, in accordance with the principles of the present invention.

Still further, in some potential embodiments, the method may facilitate at least one of adaptively, dynamically generating, and combination thereof, at least one of configurable contextual, context-based, context-dependent, context-sensitive and context-aware information, alerts, and notifications, and managing the generated information, alerts and notifications based partly on at least one of chronological, historical and current mutual context-of-presence, context-of-operation, context-of-travel, context-of-route, context-of-destination location, context-of-source location, context-of-deployment, context-of-event and context-of-use comprising inter alia, other entities, the interrelationships, interactions therebetween and ambient environment thereabout, at least one of active and passive involvement of both the tracker-cum-navigator devices 104B and target devices 104A in at least one of travel-, navigation and tracking-related transactions, both financial and non-financial, in accordance with the principles of the present invention.

Yet, in some potential embodiments, the method may facilitate at least one of adaptively, dynamically generating (or building or constructing) context, and combination thereof, via capturing one or more attributes of one or more entities (users, locations, devices) involved in a given tracking-related transaction, the interrelationships, interactions therebetween and the ambient environment thereabout, together contextual information, in accordance with the principles of the present invention. For example, and in no way limiting the scope of the invention, the entities involved in any tracking-related transaction may be at least one of the tracker-cum-navigator device 104B, target device 104A, the corresponding operating users, locations-of-presence, destinations, sources, routes, time periods of travel including start, en-route and end of journeys, modes of transportation thereof, the interrelationships, interactions therebetween and ambient environment thereabout, in accordance with the principles of the present invention.

Additionally, in some potential embodiments, the method may facilitate at least one of adaptively, dynamically analyzing, and combination thereof, the captured context(s) or contextual information, profiling the context(s) based on the results of the analyses, categorizing the context(s) based on the generated context(s) profiles, making one or more recommendations in connection with managing navigation and tracking of the target devices using the tracker-cum-navigator devices comprising generating and managing the at least one of configurable contextual, context-based, context-dependent, context-sensitive and context-aware information, alerts and notifications, managing navigation and tracking of the target devices using the tracker-cum-navigator devices comprising generating the at least one of configurable contextual, context-based, context-dependent, context-sensitive and context-aware information, alerts, and notifications based on the recommendations made, managing the generated information, alerts and notifications via at least one of reconfiguring and re-contextualizing the same, and combination thereof, based on the recommendations made, and tracking the efficacies of the recommendations made. Further, in some potential embodiments, the method may facilitate at least one of adaptive, dynamic target device detection, and combination thereof, by tracking, and vice-versa, i.e. at least one of adaptive, dynamic target device tracking, and combination thereof, by detection, in accordance with the principles of the present invention.

Still further, in some potential embodiments, for example, and in no way limiting the scope of the invention, the method may facilitate target device detection by tracking at least one of 1) the changes in location of the target device relative to changes in time, i.e. rate of change of location, 2) the changes in one or more context(s) associated with the target device relative to the changes in at least one of time and location of the at least one of target and tracker-cum-navigator device, in accordance with the principles of the present invention. In some alternative embodiments, the system 100 may facilitate the tracker devices 104B in navigating to and tracking at least one of mobile (or itinerant) and stationary (or sedentary) target devices 104A, in accordance with the principles of the present invention. For example, and in no way limiting the scope of the invention, the at least one of mobile and stationary target devices 104A may be at least one of embedded and general-purpose, at least one of portable and wearable computing and communications devices at least one of fully autonomously and partially manually-operated by at least one of itinerant users, at least one of in transit and en-route, and sedentary users, in that order. In some alternative embodiments, the system 100 may facilitate generating one or more quantified qualitative safety ranking indices for, or of, at least one of zones, regions, areas, localities, streets and lanes, as well as routes at least one of emanating therefrom and terminating thereto, and managing autonomous awareness of the at least one of target and tracker-cum-navigator devices 104A-B, of, or in connection with, the one or more one or more quantified qualitative ranking indices and use thereof, using the at least one of target devices 104A and application domain-, technology- and platform-agnostic tracker-cum-navigator devices 104B, in accordance with the principles of the present invention. Specifically, in some operational embodiments, generation, management and implementation of the one or more quantified qualitative safety ranking indices for, or of, at least one of zones, regions, areas, localities, streets and lanes, as well as routes at least one of emanating therefrom and terminating thereto and checkpoints therein, via deployment of the at least one of target devices 104A, tracker-cum-navigator devices 104B, and a combination thereof, for instance mutually in cooperation, is disclosed, in accordance with the principles of the present invention. In some exemplary embodiments, in use, both the target and tracker-cum-navigator devices 104A-B may be at least one of smart and retrofit smart, at least one of embedded and general-purpose, at least one of portable and wearable computing and communications devices and may facilitate, or be adapted to undergo, continuous training, and thus learning, upon deployment of the target devices 104A at least one of in transit and en-route via at least one of installation in the vehicle and possession of the same by the users, whereas deployment of the tracker-cum-navigator devices 104B at least one of in transit, en route and in standstill mode via at least one of installation in the vehicle and possession of the same by the users. Specifically, both the target and tracker-cum-navigator devices 104A-B may mutually cooperatively facilitate generation of the one or more quantified qualitative safety ranking indices for, or of, at least one of zones, regions, areas, localities, streets and lanes, as well as routes at least one of emanating therefrom and terminating thereto and checkpoints therein, based partly on crowd-sourced safety indices, wherein both the target and tracker-cum-navigator devices 104A-B may facilitate implementing, or be adapted to implement, geofencing in at least one of adaptive, dynamic modes, and a combination thereof, to at least one of 1) newly generate explicit user-defined geofences comprising at least one of implicit existent and explicit user-defined zones, regions, areas, the corresponding roads, streets and lanes confined thereto, the corresponding locations and positions confined therein, the corresponding routes at least one of emanating therefrom and terminating thereto and checkpoints therein and 2) redefine the existing geofences, as well as may facilitate implementing geotagging, for instance Real-Time (RT) geotagging, in at least one of adaptive, dynamic modes, and a combination thereof, to at least one of 1) newly generate explicit user-defined geotags for at least one of implicit existent and explicit user-defined checkpoints, locations and positions confined to at least one of streets and lanes, as well as routes at least one of emanating therefrom and terminating thereto, using at least one of maps and grids, in accordance with the principles of the present invention. In some preferred embodiments, the one or more quantified qualitative safety ranking indices may be subjected to later use by other target and tracker-cum-navigator devices 104A-B. In some preferred embodiments, the system of the present invention may facilitate rendering Safety-As-A-Service (SAAS) to the other target and tracker-cum-navigator devices 104A-B, in accordance with the principles of the present invention.

In some preferred embodiments, for example, and in no way limiting the scope of the invention, the system facilitating design and deployment of the at least one of application domain-, technology- and platform-agnostic tracker-cum-navigator devices, thereby facilitating implementing the method for at least one of adaptively, dynamically generating, and combination thereof, at least one of configurable contextual, context-based, context-dependent, context-sensitive and context-aware information, alerts and notifications for target devices, and managing the generated alerts and notifications via at least one of re-configuring, re-contextualizing the same, and combination thereof, may be based on the cloud computing model, in accordance with the principles of the present invention. In use, the cloud computing model may facilitate ubiquitous, convenient, on-demand network access to a shared pool of configurable computing resources, such as networks, servers, storage, applications, and services, which resources may be capable of being rapidly provisioned and released with minimal management effort or service provider interaction. Specifically, in some illustrative embodiments, the cloud computing model based system of the present invention may comprise of one or more components, namely a cloud application, cloud client, cloud infrastructure, cloud platform, cloud service and cloud storage. In some optional embodiments, the cloud computing model based system may facilitate delivery of at least one of location, contextually configurable notification and alert management services under the Software-As-A-Service (SAAS) model, which is a software licensing and delivery model, wherein one or more standalone applications render one or more corresponding business services. In some optional embodiments, unlike SAAS, which provides business services, Service-Oriented Architecture (SOA) may facilitate providing small isolated processes as a service. In use, SOA may offer services to other applications, as opposed to SAAS that may offer services to users. In some alternative embodiments, the cloud computing model based system may facilitate licensing and delivery of at least one of contextual information, notification and alert as well as location management services over the Internet to at least one of information generators (or providers or target devices) and consumers (or tracker-cum-navigator devices) as at least one of agnostic and non-agnostic services. Specifically, in use, agnostic services may be neither aware of the context in which the services may be called, nor aware of the modus operandi of implementation of the services, thereby rendering the services at least one of format-, device-, protocol-, vendor-, platform-, hardware-, business process-, database-, technology-agnostic, and combinations thereof, in accordance with the principles of the present invention.

As used in general, the term “Service-Oriented Architecture or SOA” refers to an architectural pattern in computer software design, wherein application components provide services to other components via a communications protocol, typically over a network. The principles of service-orientation are independent of any vendor, product or technology, thereby rendering the SOA at least one of vendor-, product-, technology-agnostic and combinations thereof. SOA facilitates creating a program or application focused around distinct tasks or services, wherein each piece of the program or application performs a specific task, such as retrieving a piece of data, performing an operation, etc., and wherein the tasks are performed completely independent of each other.

In some preferred embodiments involving deployment and implementation of a SAAS application software for facilitating the at least one of application domain-, technology- and platform-agnostic tracker-cum-navigator devices in implementing the method for at least one of adaptively, dynamically generating, and combination thereof, at least one of configurable contextual, context-based, context-dependent, context-sensitive and context-aware information, alerts and notifications for, or in connection with, the target devices, and managing the generated information, alerts and notifications via at least one of reconfiguring, re-contextualizing the same, and combination thereof, thereby further facilitating the tracker-cum-navigator devices in navigating to at least one of mobile and stationary target devices as well as managing autonomous awareness thereof in connection with and use of one or more quantified qualitative ranking indices for, or of, at least one of zones, regions and areas, as well as routes thereof, in the context of deployment of the present system, SOA based design may be used, in accordance with the principles of the present invention. Specifically, the SAAS application software may be designed and built on top of the SOA architecture, i.e. SOA-based SAAS application software, thereby facilitating easy scalability vis-à-vis a relatively more monolithic non-SOA-based SAAS application software. More specifically, SOA may facilitate practicing an architecture style in connection with building software, wherein an application is built or designed by assembling, or interacting with, a set of stateless, reusable, decoupled network services, e.g. web services.

In some embodiments, in the light of the need for securely controlled maximal reach (or scope of use) and deployment of the system of the present invention, and the methods practiced thereby, design and implementation of a secure proprietary client-server SOA-based SAAS application software that may be at least one of platform independent, platform-agnostic, multi-platform and cross-platform compatible is disclosed, in accordance with the principles of the present invention. For example, and in no way limiting the scope of the invention, the secure proprietary client-server SOA-based SAAS application software may be custom developed (or built or compiled) to be deployed and implemented across multiple mobile Operating Systems (or mobile OSs) supported, namely ANDROID™, IOS®, WINDOWS®, BB™, and the like. In some embodiments, by virtue of the intrinsic or inbuilt property of at least one of “platform independence,” “cross-platform compatibility” and “multi-platform compatibility”, the secure proprietary client-server SOA-based SAAS application software may directly run on any platform without special preparation or may inter-operate on multiple computer platforms, wherein the secure proprietary client-server SOA-based SAAS application software may be written in an interpreted language or pre-compiled portable bytecode for which the interpreters or run-time packages may be common or standard components of all platforms.

In some practical embodiments, for example, and in no way limiting the scope of the invention, the at least one server subsystem 102 may comprise one or more cloud servers, for instance the at least one information broker server group 102A, which in some limited embodiments, may comprise the at least one information broker server 102A, whereas at least a client subsystem 104 may comprise one or more cloud clients, for instance the at least one information provider client group 104A and at least one information consumer client group 104B, wherein in some limited embodiments, the at least one information provider client group 104A may comprise at least one information provider client (or target device) 104A, whereas the at least one information consumer client group 104B may comprise at least one information consumer client (or tracker-cum-navigator device) 104B, and wherein the at least one information broker server 102A and the one or more cloud clients 104A and 104B may be operably and communicably coupled to each other through the at least one network subsystem 106, such as a cloud network, for example at least one of a Cloud-Enabled Network (CEN) and Cloud-Based Network (CBN), for instance a collaborative CBN based on a client-server model for cloud computing.

In some specific embodiments, the at least one information broker server 102A may comprise at least one of a cloud server, cloud storage, cloud database, and combinations thereof. For example, and in no way limiting the scope of the invention, in some potential embodiments, the information broker cloud server 102A may comprise a cloud storage, cloud database (both neither numbered, nor shown), and a combination thereof. In some exemplary embodiments, the information broker cloud server 102A may be a logical server that is built, hosted and delivered through implementation of a cloud platform (neither shown, nor numbered), deployed in the context of the system 100 over the network subsystem 106, for instance the Internet. By virtue of functionality, the information broker cloud server 102A may possess and exhibit similar capabilities and functionality to a typical server, but may be accessed remotely from a cloud service provider (neither shown, nor numbered), for instance the broker. In some alternative embodiments, the information broker cloud server 102A may primarily be an Infrastructure-As-A-Service (IAAS) based cloud service model. For example, and in no way limiting the scope of the invention, the information broker cloud server 102A may be at least one of logical and physical cloud server, wherein the logical information broker cloud server 102A may be delivered through server virtualization, and wherein under the IAAS based cloud service delivery model, the physical information broker cloud server 102A may be logically distributed into two or more logical information broker cloud servers 102A, each of which may have separate OSs, UIs and apps, although they may share physical components from the underlying physical information broker cloud server 102A, whereas the physical information broker cloud server 102A may also be accessed through the Internet remotely, however the physical information broker cloud server 102A may not be shared or distributed, and which may be commonly known as a dedicated cloud server. In some specific embodiments, the cloud storage may be an online network storage facilitating storing data or information therein, and accessing the stored data or information using multiple cloud clients 104A and 104B. More specifically, for example, and in no way limiting the scope of the invention, the cloud storage may be deployed in the following configurations or deployment models, namely at least one of a public cloud, private cloud, community cloud and one or more combinations thereof, namely a hybrid cloud, and others, namely distributed cloud, Intercloud and Multicloud. In some advantageous embodiments, for example, and in no way limiting the scope of the invention, the cloud storage may facilitate agility, flexibility, scalability, multi-tenancy, and security from the storage perspective. In some illustrative embodiments, the cloud storage may be a model of data storage, wherein the digital data may be stored in logical pools, whereas the physical storage may span across multiple servers (and often locations), and the physical environment may be typically owned and managed by a hosting company.

In some embodiments involving deployment and implementation of the CEN in the context of the present system, the CEN may facilitate moving management and certain aspects of control, such as policy definition, into the cloud, however retaining connectivity and packet-mode functions, such as routing, switching and security services, locally and often in hardware. On the contrary, in some embodiments involving deployment and implementation of the CBN, the CBN may facilitate moving all core networking functions, including addressing and the actual packet path, into the cloud and eliminating the need for any local hardware other than that which provides an Internet connection. Specifically, the CBN may be referred to as Network-As-A-Service (NAAS), since NAAS follows the same subscription and delivery model as Software-As-A-Service (SAAS) solutions. In some embodiments involving delivery of NAAS via CBN, the NAAS may be rendered as a cloud-based service, wherein users may be allowed to purchase computing infrastructure on a compute/hour basis. By contrast, in some embodiments, users may contract with a hosting provider to manage hosted servers. Although, both CBN and CEN may facilitate delivering computing as a service, but the economics, extensibility, and capabilities between the two approaches may vary widely. In the same vein, in some embodiments involving deployment and implementation of cloud-based NAAS, the cloud-based NAAS may be built as an overlay on global cloud data centers and utilize Software-Defined Networking (SDN) and virtualization technologies to provide an elastic and resilient NAAS, thereby facilitating hosting multiple virtual network services. In some scenarios, one or more NAAS providers may simply host single-function network equipment or virtual appliances in co-location centers and sell access and management as service.

In some practical embodiments, the CBN may only require an Internet connection and may work over any physical infrastructure, wired or wireless, public or private. In addition, the CBN may have the added benefit of not requiring any additional hardware beyond that required for Internet connectivity. In some embodiments, by virtue of design and implementation, the cloud network may be similar to a Virtual Private Network (VPN) because the cloud network may enable users to securely access files, printers, applications, etc. from anywhere in the world, on any device. However, the cloud network may be multi-tenant private virtual cloud network that overlay the Internet. In use, the VPN may function like a borderless LAN and may provide fully switched, any-to-any connectivity between servers, PCs, and mobile devices from anywhere. In some practical embodiments, the cloud database may be a database that typically runs on the information broker cloud server 102A, whereby access thereto may be provided as a service. For purposes of clarity and expediency, the information provider client group 104A may be hereinafter interchangeably referred to as “information (or location) provider client group,” “location information provider client group,” “target (or targeted) client group,” “target device” and “trackee (or tracked) client group.” Likewise, for purposes of clarity and expediency, the information consumer client group 104B may be hereinafter interchangeably referred to as “information (or location) consumer client group,” “location information consumer client group,” “tracker-cum-navigator device” and “tracker and navigator client group.”

In some embodiments, for example, and in no way limiting the scope of the invention, the server subsystem 102 may comprise the at least one of information broker cloud server 102A and cloud storage. Specifically, the cloud storage may be an online network storage facilitating storing data or information therein, and accessing the stored data or information using multiple clients 104A-B. More specifically, for example, and in no way limiting the scope of the invention, the cloud storage may be deployed in the following configurations or deployment models, namely at least one of a public cloud, private cloud, community cloud and one or more combinations thereof, namely a hybrid cloud, and others, namely distributed cloud, Intercloud and Multicloud. In some advantageous embodiments, for example, and in no way limiting the scope of the invention, the cloud storage may facilitate agility, flexibility, scalability, multi-tenancy, and security from the storage perspective. In some limited embodiments, the at least one information broker cloud server 102A may be at least one of a cloud server 102A and cloud storage. In some practical embodiments, the information broker cloud server 102A may comprise one or more host computing units 108. Each of the host computing units 108 may comprise a first microprocessor subunit 110, first memory subunit 112, first Input/Output (I/O) subunit 114 and first set of support circuits 116, respectively. In addition, each of the host computing units 108 may comprise a first communication subunit 118 coupled to the first I/O subunit 114. The first communication subunit 118 may comprise a first wireless transceiver 120.

For example, and in no way limiting the scope of the invention, in some practical embodiments, the first wireless transceiver 120 may comprise at least one of a General Packet Radio Service (GPRS) transceiver, Global System for Mobile Communications (GSM) transceiver, Near Field Communication (NFC) transceiver, BLUETOOTH® transceiver, and the like. In addition, each of the host computing units 108 may comprise a first display subunit 122. In some embodiments, both the first communication subunit 118 and first display subunit 122 may be coupled to the first I/O subunit 114. In addition, each of the host computing units 108 may comprise a first positioning subunit 124. For example, and in no way limiting the scope of the invention, the first positioning subunit 124 may be based on Global Positioning System (GPS).

In some practical embodiments, the first memory subunit 112 may comprise a first Operating System (OS) 126. Specifically, the first OS 126 may be at least one of a platform agnostic and independent OS. In addition, the first memory subunit 112 may comprise the server-side of a secure proprietary SOA-based Location, Notification and Alert Management Service Broker-As-A-Service (SOALNAMSBAAS) modular application software 128. In some practical embodiments, the SOALNAMSBAAS modular application software 128 may comprise a Location-As-A-Service (LAAS) application software component 128A and a Notification/Alert-As-A-Service (NAAAS) application software component 128B (both not shown here explicitly).

In some practical embodiments, the first Operating System (OS) 126 may be at least one of a cloud-based, cloud-enabled and cloud OS. In some specific embodiments, the first OS 126 may be a platform agnostic cloud OS. Specifically, the cloud OS 126 may be designed to operate within cloud computing and virtualization environments. More specifically, the cloud OS or cloud-based OS 126 may be a set of applications and programs running on each of the host computing units 108. Except that, the whole service relies on Internet, and the applications available within each of the host computing units 108, as well as each of the host computing units 108 in entirety, may not be installed on the cloud clients 104A-B.

In some alternative embodiments, the first OS 126 may be Internet OS, which refers to any type of OS designed to run all the applications and services thereof, or therefor, through an Internet client, generally a web browser. Advantageously, the Internet OS 126 may run on a thin client, for instance cloud clients 104A-B, thereby facilitating cheaper and more easily manageable computer systems. In some embodiments involving deployment and implementation of the Internet OS, all applications may be designed based on open standards to be cross-platform compatible, thereby facilitating eliminating dependency of client-specific applications, and preferences thereof, upon a single computer via uploading and storing the client-specific applications, and preferences thereof, on the cloud. As a consequence, the Internet OS 126 may serve as the perfect type of platform for SAAS. In some practical embodiments, the first OS 126 may be cloud OS. In some specific embodiments, the first OS 126 may be a platform agnostic cloud server OS.

In some practical embodiments, specifically the secure proprietary SOALNAMSBAAS modular application software 128 may be at least one of a desktop web application software and mobile web application software. More specifically, in some practical embodiments, for example, and in no way limiting the scope of the invention, the secure proprietary SOALNAMSBAAS modular application software 128 may be a client-server application software respectively, which a client (or User Interface or UI or Web UI (WUI) or Web-based UI thereof), for instance the cloud clients 104A-B comprising the client-side of the secure proprietary client-server SOALNAMSBAAS modular application software 128, or the UI therefor, may run in a web browser including a mobile web browser (not numbered and shown schematically), installed on the cloud clients 104A-B.

More specifically, in some practical embodiments, for example, and in no way limiting the scope of the invention, the secure proprietary client-server SOALNAMSBAAS modular application software 128 may be at least one of a distributed client-server application software comprising both client and server software, for instance both the client- and server-sides and of the secure proprietary client-server SOALNAMSBAAS modular application software 128, wherein the client-side of the secure proprietary client-server SOALNAMSBAAS modular application software 128 may be a client-agnostic web application software, or at least one of a client-agnostic desktop web application software, or at least one of a client-agnostic mobile web application software.

In some potential embodiments, for example and in no way limiting the scope of the invention, the secure proprietary client-server SOALNAMSBAAS modular application software 128 may be at least one of a mobile web, desktop web and hybrid application software. In some exemplary embodiments involving addressing inabilities of at least one of a desktop and mobile web application software to access one or more sensors of at least one of smart fixed, portable and wearable computing and communications devices, whilst maintaining the cross-platform support thereof, the hybrid application software may facilitate accessing the one or more sensors of the at least one of smart fixed, portable and wearable computing and communications devices via running inside at least one of a desktop and mobile web browser. However, from the standpoint of design and implementation, unlike the at least one of desktop and mobile web application software, the at least one of desktop and mobile web browser may be embedded inside a container application software native to the at least one of smart fixed, portable and wearable computing and communications devices, thereby providing a bridge between the hybrid application software and low-level functions of the at least one of smart fixed, portable and wearable computing and communications devices. Yet, in some practical embodiments, for example, and in no way limiting the scope of the invention, the secure proprietary client-server SOALNAMSBAAS modular application software 128 may be a cloud application software. Specifically, the secure proprietary client-server SOALNAMSBAAS modular cloud application software 128 may often facilitate eliminating the need to install and run the cloud application software on the end user client device, for instance the cloud clients 104A-B, thus reducing software maintenance, ongoing operations, and support. In some practical embodiments, for example, and in no way limiting the scope of the invention, the cloud clients (or target devices and tracker-cum-navigator devices) 104A-B may be at least one of a fat, thin and hybrid client subject to the hardware and software requirements of the secure proprietary client-server SOALNAMSBAAS modular web application software 128 in connection with one or more possible scenarios.

In some alternative embodiments, for example, and in no way limiting the scope of the invention, each of the thin clients 104A-B may be a web thin client. In use, the web thin clients 104A-B may only provide a web browser (not numbered and shown schematically), and rely on one or more web application software, including, but not limited to, for instance the secure proprietary client-server SOALNAMSBAAS modular web application software 128, to provide at least one of application-specific and general-purpose computing functionality. However, in use, the secure proprietary client-server SOALNAMSBAAS modular web application software 128 may use web storage to store some data locally, e.g. for “offline mode”, and perform significant processing tasks as well. In some scenarios involving deployment and implementation of Rich Internet Applications (RIAs) on web thin clients, for instance at least a plurality of the web thin clients 104A-B, the RIAs may cross the boundary, for instance HTML5 web applications leverage browsers as run-time environments through the use of a cache manifest or so called “packaged apps”, for instance in case of FIREFOX® OS and CHROME®. Further, examples of web thin clients include CHROMEBOOK®(s) and CHROMEBOXE®(s), which run CHROME® OS, and phones running FIREFOX® OS. Still further, CHROMEBOOK®(s) and CHROMEBOXE®(s) also have the capability of remote desktop using the free CHROME® Remote Desktop browser extension, which means, other than a web thin client, the CHROMEBOOK®(s) and CHROMEBOXE®(s) are also used as an ultra-thin client to access PC or Mac applications that do not run on the CHROMEBOOK® directly. In use, the CHROMEBOOK®(s) and CHROMEBOXE®(s) are used as a web thin client and an ultra-thin-client simultaneously, with the user switching between web browser and PC or Mac application windows with a click. CHROMEBOOK®(s) are also capable of storing user documents locally, with the exception of media files, which have a dedicated player application to play, all such files are only opened and processed with web applications, since traditional desktop applications cannot be installed in CHROME OS.

In some alternative embodiments, the cloud clients 104A-B may comprise computer hardware and/or software that relies on cloud computing for application software delivery, or that is specifically designed for delivery of cloud services and that, in either case, is essentially useless without cloud computing. Examples include some computers, phones and other devices, operating systems and browsers. In use, users may access cloud computing using networked client devices, such as desktop computers, laptops, tablets and smartphones and any Ethernet enabled device, such as home automation gadgets. In some scenarios, one or more of the aforementioned devices, for instance at least a plurality of the cloud clients 104A-B rely on cloud computing for all or a majority of the applications thereof so as to be essentially useless without cloud computing. Examples are thin clients and the browser-based CHROMEBOOK®. In some other scenarios, many cloud applications do not require specific software on the client and instead use a web browser to interact with the cloud application. With AJAX and HTML5 the web User Interfaces (UIs) achieves a similar, or even better, look and feel to native applications. Some cloud applications, however, support specific client software dedicated to these applications (e.g., virtual desktop clients and most email clients). Some legacy applications (line of business applications that until now have been prevalent in thin client computing) are delivered via a screen-sharing technology.

In some operational embodiments, in operation, the secure proprietary client-server SOALNAMSBAAS modular web application software 128 may provide a better way to share the workload. The client-side of the secure proprietary client-server SOALNAMSBAAS modular web application software 128 installed and running on any client, for instance the client subsystem 104 comprising inter alia a plurality of the at least one of embedded and general-purpose, at least one of fixed, portable and wearable computing and communications devices, may always initiate a connection to the server, for instance the sever subsystem 102 comprising at least one host computing unit 108, while the server-side of the secure proprietary client-server SOALNAMSBAAS modular web application software 128 may always wait for requests from any client. In some limited embodiments, the client subsystem 104 may comprise one or more of the at least one information (or location) provider client group 104A and at least one information (or location) consumer client group 104B. Each of the at least one information (or location) provider client group 104A and at least one information (or location) consumer client group 104B may comprise one or more of at least one of smart and regular, at least one of embedded and general-purpose, at least one of fixed, portable and wearable computing and communications devices, with at least one of inbuilt, embedded Global Positioning System (GPS) capability and add-on GPS capability by virtue of a retrofit (coupled) thereto, respectively.

In some embodiments, each of the at least one information (or location) provider client group 104A and at least one information (or location) consumer client group 104B may comprise one or more of at least one of smart and regular, at least one of a portable computing device, portable communications device and a combination thereof, for instance at least one of a smart and regular portable computing and communications device, with at least one of inbuilt Global Positioning System (GPS) capability and add-on GPS capability by virtue of a retrofit thereto, respectively. In some embodiments, the smart portable computing devices may be at least one of a smart portable computer, smart tablet computer, smart Personal Digital Assistant (PDA), a smart ultra-mobile PC, a smart phone, smart carputer, smart pen top computer, smart speaker, and the like. Likewise, in some embodiments, the smart portable communications devices may be at least one of a smart mobile device, and the like. In some embodiments, the client subsystem may comprise one or more of at least one of a smart wearable computing device, smart wearable communications device and a combination thereof, for instance a smart wearable computing and communications device. For example, and in no way limiting the scope of the invention, the smart wearable computing devices may be at least one of a smart watch, smart band, smart glass, smart speaker, smart camera, smart sensors, smart microphone, smart shoe, and the like. In some embodiments, the client subsystem may comprise one or more of a smart fixed computing and communications device. For example, and in no way limiting the scope of the invention, the smart fixed computing and communications device may be a smart PC or at least one of a smart device, smart TV, smart display. In some practical embodiments, the client subsystem 104 may comprise one or more of at least one of partially manually-operated smart fixed, portable and wearable computing and communications devices. Stated differently, or otherwise, for example, and in no way limiting the scope of the invention, the client subsystem 104 may comprise at least one of smart fixed, portable and wearable computing and communications devices 104 owned and partially manually-operated by one or more users. In some alternative embodiments, the client subsystem 104 may comprise one or more of at least one of fully autonomous, fully automatic, and a combination thereof, at least one of smart fixed and portable devices, appliances, apparatuses, connected products, and the like.

With reference to FIG. 1, in some practical embodiments, each of the 1) at least one of partially manually-operated, smart fixed, portable and wearable computing and communications devices serving or posing as the target and tracker-cum-navigator devices 104A-B and 2) at least one of fully, partially autonomous, automatic, and the combination thereof, smart devices, smart appliances, smart apparatuses and smart connected products serving or posing as the target and tracker-cum-navigator devices 104A-B (or cloud clients including embedded cloud clients) may comprise a second microprocessor subunit 134, for instance an embedded microprocessor in the case of the at least one of fully autonomous, automatic, and combination thereof, smart devices, smart appliances, smart apparatuses and smart connected products 104A-B (or embedded cloud clients), the second memory subunit 136, for instance at least one of an Embedded DRAM (eDRAM), a Dynamic Random-Access Memory (DRAM), and a flash memory in the case of the at least one of fully autonomous, automatic, and combination thereof, smart devices, smart appliances, smart apparatuses and smart connected products 104A-B (or embedded cloud clients), a second Input/Output (I/O) subunit 138 and second set of support circuits 140, respectively. In addition, each of the cloud clients 104A-B may comprise a second communication subunit 142, for instance an embedded communication unit in the case of the embedded cloud clients 104A-B, coupled to the second I/O subunit 138. The second communication subunit 142 may comprise a second wireless transceiver 144, for instance an embedded wireless transceiver in the case of the embedded cloud clients 104A-B.

For example, and in no way limiting the scope of the invention, the second wireless transceiver 144 may comprise at least one of a General Packet Radio Service (GPRS) transceiver, for instance an embedded GPRS transceiver in the case of the embedded cloud clients 104A-B, Global System for Mobile Communications (GSM) transceiver, for instance an embedded GSM transceiver in the case of the embedded cloud clients 104A-B, Near Field Communication (NFC) transceiver, for instance an embedded NFC transceiver in the case of the embedded cloud clients 104A-B, BLUETOOTH® transceiver, for instance an embedded NFC transceiver in the case of the embedded cloud clients 104A-B, and the like. In addition, each of the cloud clients 104A-B may comprise a second display subunit 146, for instance an embedded display unit in the case of the embedded cloud clients 104A-B. In some embodiments, both the second communication subunit 142 and second display subunit 146 may be coupled to the second I/O subunit 138, for instance an embedded I/O unit in the case of the embedded cloud clients 104A-B. In addition, each of the cloud clients 104A-B may comprise a second positioning subunit 148. For example, and in no way limiting the scope of the invention, the second positioning subunit 148 may be based on Global Positioning System (GPS), for instance an embedded GPS unit in the case of the embedded cloud clients 104A-B.

The second memory subunit 136 may comprise a second OS 150. For example, and in no way limiting the scope of the invention, the second OS 150 may be a mobile OS. Specifically, the mobile OS 150 may be at least one of a platform independent and agnostic mobile OS.

In some practical embodiments, the second OS 150 may be at least one of cloud-based, cloud-enabled and cloud OS. In some specific embodiments, the second OS 150 may be a platform agnostic cloud OS. For instance, the platform agnostic mobile OS 150 may be ANDROID™ OS. For example, and in no way limiting the scope of the invention, in some embodiments, the platform agnostic mobile OS 150 may serve as a client-side OS for the cloud clients 104A-B, such as GOOGLE®'s CHROME®, that is designed to load all applications from the Internet or local network (the cloud).

In some alternative embodiments involving deployment of embedded devices or apparatuses as cloud clients at least one of partially and fully autonomously operated, the second OS 150 may be an embedded OS. Embedded OS are designed to be compact, efficient at resource usage, and reliable, forsaking many functions that non-embedded computer operating systems provide, and which may not be used by the specialized applications run thereupon. Embedded OS are frequently also referred to as Real-Time Operating Systems, and the term RTOS is often used as a synonym for embedded operating system. Usually, the hardware running the embedded OS may be limited in resources, such as RAM and ROM, therefore systems made for embedded hardware tend to be specific, which means that due to the available resources (low if compared to non-embedded systems) the embedded systems may be created to cover specific tasks or scopes.

Further, the second memory subunit 136 may comprise the client-side of the secure proprietary client-server SOALNAMSBAAS modular web application software 128.

In some embodiments involving deployment and implementation of the system facilitating design and deployment of the at least one of application domain-, technology-and platform-agnostic tracker-cum-navigator devices, thereby facilitating implementing the method for at least one of adaptively, dynamically generating, and combination thereof, at least one of configurable contextual, context-based, context-dependent, context-sensitive and context-aware information, alerts and notifications for tracker devices, and managing the generated information, alerts and notifications via at least one of reconfiguring, re-contextualizing the same, and combination thereof, the at least one information broker server may facilitate adaptively and dynamically rendering at least one of location-based, location-dependent, location-sensitive, location-aware, information-based, information-dependent, information-sensitive, information-aware, context-based, context-dependent, context-aware services, and combinations thereof, for instance contextual information, location, notification and alert management-as-a-service via implementing the SAAS cloud computing service model, in accordance with the principles of the present invention.

In some operational embodiments, by virtue of the inbuilt and add-on GPS capabilities, each of the plurality of at least one of smart and regular (retrofit smart), at least one of portable and wearable computing and communications devices 104A-B may at least one of actively and passively determine the locations thereof, and thus may be location aware. Network Location Awareness (NLA) describes the locations of the plurality of at least one of smart and regular, at least one of portable and wearable computing and communications devices 104A-B in the network subsystem 106.

Location Awareness (LA) without the active participation of the plurality of at least one of smart and regular, at least one of portable and wearable computing and communications devices 104A-B is considered as non-cooperative locating or detection.

In some practical embodiments, at least one of safety, security, location and contextual information management of at least one of fully autonomously and partially manually operable, at least one of embedded and general-purpose, at least one of portable and wearable computing and communications devices, the at least one of operators, owners and users thereof, belonging to the information provider client group serving as the target devices and information consumer client group serving as the tracker-cum-navigator devices in the context of the deployment of the present system is disclosed, in accordance with the principles of the present invention. Specifically, in use, Authentication, Authorization and Accounting (AAA) of the at least one of autonomous and partially user-operated, at least one of embedded and general-purpose, at least one of portable and wearable computing and communications devices belonging to at least one of the location information provider client group serving as the target devices and location information consumer client group serving as the tracker-cum-navigator devices in the context of the deployment of the present system is disclosed, in accordance with the principles of the present invention. More specifically, each of the at least one of autonomous and partially user-operated, at least one of embedded and general-purpose, portable computing and communications devices belonging to the at least one of location information provider and location information consumer client groups correspondingly serving as the target and tracker-cum-navigator devices, in that order, may be subjected to AAA by the information broker server, prior to accessing and availing the services offered or rendered thereby. Upon successful AAA, each of the at least one of autonomous and partially user-operated, at least one of embedded and general-purpose, portable computing and communications devices belonging to the at least one of location information provider and consumer client groups may be allowed to access and avail at least one of safety, security context, location, notification and alert management services, such as location-sensitive, location-based, location-aware, location-dependent services, rendered by the information broker server as a service, in accordance with the principles of the present invention.

With reference to FIG. 1, in some operational embodiments, in use, at least one potential subscriber (or new aspiring user), for example at least one potential information-providing user, for instance the target device 104A and user thereof, information-consuming user, for instance the tracker-cum-navigator device 104B and user thereof, and a combination thereof, of the secure proprietary client-server SOALNAMSBAAS modular web application software 128 may be desirous to at least one of register and sign up for a new user account, for instance a paid subscription-based account, against payment of a fee, for instance a mandatory subscription fee, thereby facilitating Authenticated, Authorized and Accounted (AAA) mandatorily paid access thereto, access controls therefor, as well as one or more SAAS-based application services associated therewith, and rendered thereunder as a service, later to the potential subscriber posing as a return user, subject to successful registration of the potential subscriber as a paid or registered subscriber, for instance the at least one registered information-generating user, information-consuming user, and combination thereof, posing as the return user.

In use, in some operational embodiments, during registration and subsequent to completion of any and all formalities therefor, such as responding to at least subjective and objective questionnaire posed to capture at least one of the overall profile, requirements, expectations, requests, demands of the potentially subscribing users, and corresponding specifications thereof, as well as combinations thereof, the potentially subscribing (or newly registering user) may pay the mandatory subscription fee, against creation and management (or maintenance) of the paid subscription-based account, grant of AAA access thereto and access controls therefor, as well as the SAAS-based application services rendered thereunder, via an online payment gateway (neither numbered, nor shown), upon remotely accessing the website hosting an online digital distribution app store (or app marketplace or SAAS app store) (neither numbered, nor shown) offering the secure proprietary client-server SOALNAMSBAAS modular web application software 128 licensed and delivered as at least one of a freeware and payware, and hosted and running on a cloud server, for instance the information broker cloud server 102A, using a web browser including a mobile web browser (not numbered and shown schematically) running on a cloud client, for instance at least one of web and cloud, at least one of a fat, thin and hybrid belonging to the client subsystem 104 comprising the cloud clients (or both the target and tracker-cum-navigator devices) 104A-B.

For example, and in no way limiting the scope of the invention, the online app marketplace, may be a type of e-commerce website, wherein information in connection with at least one of mobile and desktop, at least one of native, web and hybrid application software, for instance at least one of a SAAS mobile web application, SAAS hybrid web application and SAAS web application, is provided by at least one of multiple First, Second and Third parties, whereas transactions are processed by the online app marketplace operator. Specifically, in use, the at least one information-generating (or the target device 104A), information-consuming user (or the tracker-cum-navigator device 104B), and combination thereof, may register for at least one of subsequent conditionally free and paid access to use, for instance 1) for the information consumer cloud clients (or the tracker-cum-navigator devices) 104B to A) track the target devices 104A, B) navigate to the target devices 104A, C) at least one of adaptively, dynamically generate, and combination thereof, at least one of configurable contextual, context-based, context-dependent, context-sensitive and context-aware information, alerts and notifications for, or in connection with, the target devices, i.e. information provider cloud clients 104A, and D) manage the generated alerts and notifications via at least one of reconfiguring, re-contextualizing the same, and combination thereof, and 2) for the target devices 104A to A) generate at least one of contextual, spatial, temporal and locational information associated therewith for consumption by the tracker-cum-navigator devices 104B, B) selectively generate a list of the one or more tracker-cum-navigator devices 104B corresponding to each of the target devices 104A and preapproved thereby to access the corresponding at least one of contextual, spatial, temporal and locational associated therewith, and C) at least one of creating, defining, modifying, deleting, saving and sharing routes, maps, and the checkpoints therein, the secure proprietary client-server SOALNAMSBAAS modular web application software 128 correspondingly at least one of free as freeware under freemium service and against payment of a subscription fee as payware under premium service charged by at least one of a First-Party online app marketplace operator, Third-Party online app marketplace operator, and a combination thereof, hosting and managing the online app marketplace offering the secure proprietary client-server SOALNAMSBAAS modular web application software 128.

Upon successful sign up, at least one newly registered user, for instance the at least one information-generating user (or the target device 104A user), information-consuming user (or the tracker-cum-navigator device 104B user), and combination thereof, may be issued unique log-in credentials, such as a User Identifier (User ID or UID) and Password (PWD), against successful completion of formalities for registration, using which the newly registered user may log into (or log on or sign in or sign on) to the online app marketplace at a later period in time as a return user.

Further, with reference to FIG. 1, upon successfully logging in to the website hosting the online app marketplace or store using the paid subscription-based account, the newly registered return user (or subscriber) of the secure proprietary client-server SOALNAMSBAAS modular web application software 128 may be remotely subjected to Authentication, Authorization and Accounting (AAA) by the hosting server, for instance the information broker server 102A, which may comprise an AAA engine (neither numbered, nor shown).

Still further, with reference to FIG. 1, in some operational embodiments involving successful AAA, a registered AAA return user may be redirected to the home or index page of the website hosting the online app marketplace or store on the server subsystem 102, and managed thereby. The online app marketplace or store may comprise a Graphics User Interface (GUI), for instance a Web-based User Interface or Web User Interface (WUI).

Each of the at least one of autonomous and partially user-operated, at least one of smart and retrofit smart, at least one of embedded and general-purpose, at least one of fixed, portable and wearable computing and communications devices belonging to the information provider cloud client group serving as the target devices 104A, which target devices 104A may be at least one of location- and context-aware, may be capable of, or adapted to, transmitting (or transmit) (or submitting or uploading) at least one of contextual, spatial, temporal and locational information thereof, or associated therewith, to the cloud information broker server 102A, subject to Authentication, Authorization and Accounting (AAA) of the target devices 104A thereby.

Upon successful AAA by the information broker cloud server 102A, each of the at least one of autonomous and partially user-operated, at least one of smart and retrofit smart, at least one of embedded and general, portable and wearable computing and communications devices belonging to the information provider cloud client group 104A serving as the target devices may transmit a corresponding selectively generated list of each of the at least one of autonomous and partially user-operated, at least one of smart and retrofit smart, at least one of embedded and general, portable and wearable computing and communications devices belonging to the information consumer cloud client group 104B serving as the tracker-cum-navigator devices explicitly approved by the corresponding target device 104A, and thus allowed to access, retrieve and use the at least one of contextual, spatial, temporal and locational information associated therewith. Specifically, upon successful AAA by the information broker cloud server 102A, each of the at least one of autonomous and user-operated, at least one of smart and retrofit smart, at least one of embedded and general, portable and wearable computing and communications devices belonging to the information provider cloud client group 104A serving as the target devices may transmit the corresponding pre-approved list of each of the at least one of autonomous and user-operated, at least one of smart and retrofit smart, at least one of embedded and general, portable and wearable computing and communications devices belonging to the information consumer cloud client group 104B serving as the tracker-cum-navigator devices explicitly allowed by each of the corresponding at least one of autonomous and user-operated, at least one of smart and retrofit smart, at least one of embedded and general, portable and wearable computing and communications devices belonging to the information provider cloud client group 104A serving as the target devices to access, retrieve and use the at least one of contextual, spatial, temporal and locational information associated therewith or corresponding thereto.

In some embodiments, generation and holistic management of at least one of configurable contextual, context-based, context-dependent, context-sensitive and context-aware information, alerts, as well as notifications, for instance at least one of configurable locational, location-based, location-dependent, location-sensitive and location-aware information, alerts, as well as notifications, via deployment and implementation of the secure proprietary client-server SOALNAMSBAAS modular web application software 128, thereby facilitating the at least one of autonomous and partially user-operated, at least one of smart and retrofit smart, at least one of embedded and general-purpose, portable and wearable computing and communications devices belonging to the cloud information consumer client group 104B serving as the tracker-cum-navigator devices in navigating and tracking to the at least one of autonomous and partially user-operated, at least one of smart and retrofit smart, at least one of embedded and general-purpose, portable and wearable computing and communications devices belonging to the cloud information provider client group 104A serving as the target devices is disclosed, in accordance with the principles of the present invention. Specifically, the secure proprietary client-server SOALNAMSBAAS modular web application software 128 may facilitate AAA of both the tracker-cum-navigator devices 104B and target devices 104A. More specifically, upon successful AAA of the target devices 104A and tracker-cum-navigator devices 104B, the secure proprietary client-server SOALNAMSBAAS modular web application software 128 may facilitate reception, storage, processing and transmission of the at least one of 1) contextual and locational information associated with the target devices 104A, and 2) configurable contextual, context-based, context-dependent, context-sensitive and context-aware information, alerts, as well as notifications, for instance at least one of configurable locational, location-based, location-dependent, location-sensitive and location-aware information, alerts, as well as notifications, between, or from and to, the target devices 104A and tracker-cum-navigator devices 104B via the information broker server 102A. Still, more specifically, the secure proprietary client-server SOALNAMSBAAS modular web application software 128 may facilitate AAA of the target devices 104A whilst, or prior to, reception of the at least one of 1) contextual and locational information associated with the target devices 104A and 2) a list corresponding to each of the target devices 104A comprising one or more of the tracker-cum-navigator devices 104B preapproved by each of the corresponding target devices 104A, using the information broker server 102A; and a first level AAA and a second level preapproved list-based membership verification of the tracker-cum-navigator devices 104B whilst, or prior to, providing access to the received, stored and processed at least one of contextual and locational information associated with the target devices 104A in the information broker server 102A, and transmitting at least one of configurable contextual, context-based, context-dependent, context-sensitive and context-aware information, for instance at least one of configurable locational, location-based, location-dependent, location-sensitive and location-aware information, alerts and notifications, from the tracker-cum-navigator devices 104B to the information server broker 102A. Thus, the secure proprietary client-server SOALNAMSBAAS modular web application software 128 may facilitate AAA of both the target devices 104A and tracker-cum-navigator devices 104B. Upon successful AAA of each of the at least one of autonomous and partially user-operated, at least one of smart and retrofit smart, at least one of embedded and general-purpose, at least one of portable and wearable computing and communications devices belonging to the cloud information provider client group 104A serving as the target devices, the secure proprietary client-server SOALNAMSBAAS modular web application software 128 may facilitate transmission of the at least one of contextual, context-based, context-dependent, context-sensitive and context-aware information, for instance at least one of locational, location-based, location-dependent, location-sensitive and location-aware information therefrom, accompanied by the pre-approved list of each of the corresponding at least one of autonomous and user-operated, at least one of smart and retrofit smart, at least one of embedded and general, portable and wearable computing and communications devices belonging to the information consumer cloud client group 104B serving as the tracker-cum-navigator devices, which may be authorized by the corresponding target devices 104A to access the received, stored and processed at least one of contextual, context-based, context-dependent, context-sensitive and context-aware information, for instance at least one of locational, location-based, location-dependent, location-sensitive and location-aware information, supplied therefrom to the brokers 102A. In some limited embodiments, for example, and in no way limiting the scope of the invention, in use, the secure proprietary client-server SOALNAMSBAAS modular web application software 128 may facilitate transmission of the location information corresponding to each of the target devices 104A, each of which target devices 104A may be pre-authenticated, pre-authorized and pre-accounted by the brokers 102A, in response to request made by one or more of the tracker-cum-navigator devices 104B.

With reference to FIG. 1, in some potential embodiments, the online digital distribution app store (or app marketplace or SAAS app store) may facilitate providing digital distribution platform for mobile apps, such as at least one of mobile and desktop, at least one of native, web and hybrid application software, example at least one of a SAAS mobile web application, SAAS hybrid web application and SAAS web application software, for instance the secure proprietary client-server SOALNAMSBAAS modular web application software 128. In operation, the online app store may facilitate organizing the application software offered thereby based on the following considerations: 1) the function(s) provided by the application software (including games, multimedia or productivity), including, but not limited to, the secure proprietary client-server SOALNAMSBAAS modular web application software 128, 2) the device, for instance the cloud clients 104A-B, for which the application software may be designed, and 3) the Operating System (OS) on which the application software may be capable of running, or adapted to, run. For example, the application software may be designed to run on specific devices, and are written for a specific OS, such as IOS®, Mac OS X or OS X®, WINDOWS®, or ANDROID™.

In some practical embodiments, the online app store may facilitate users to browse, using a mobile browser, through the different app categories and selectively view information about each app, such as reviews or ratings, and acquire, for instance obtain the app, for instance the secure proprietary client-server SOALNAMSBAAS modular web application software 128, against payment of at least one of a predetermined fee and Free of Charge/Cost (FOC). The selected app may be downloaded at least one of automatically and manually. For instance, in some scenarios the selected app may be offered as an automatic download. Upon downloading the user may install the downloaded app. In some embodiments, the online app store may facilitate automatic removal of one or more installed programs or apps from the portable computing and communications devices under certain conditions, with the goal of protecting the user against malicious software.

In some practical embodiments, the online app store may comprise, and thus offer the client-side of the secure proprietary client-server SOALNAMSBAAS modular web application software 128, designed and implemented in accordance with the principles of the present invention. In some preferred embodiments, the first memory subunit 112 of the cloud information broker server 102A may comprise the server-side app store, whereas the second memory subunit 136 of the at least one of target and tracker-cum-navigator devices 104A-B may comprise the client-side app store. Specifically, the client-side app store may comprise one or more apps, for instance the secure proprietary client-server SOALNAMSBAAS modular web application software 128, displayable on the second display subunit 146, and available for use (implementation or execution) upon selective downloading therefrom, and accessible thereafter. More specifically, the first memory sub-unit 112 may comprise the second OS 150 and the client-side of the secure proprietary client-server SOALNAMSBAAS modular web application software 128, upon selective downloading from the app store.

In some embodiments involving subscription business models using or based on Software-As-A-Service (SAAS), the users are provided access to the apps and databases, for instance SAAS-based apps and SAAS-based databases.

Cloud providers manage the infrastructure and platforms that run the apps, for instance the SAAS-based app store comprising the secure proprietary client-server SOALNAMSBAAS modular web application software, and SAAS-based databases or Database-As-A-Service (DBAAS).

The term “Database-As-A-Service or DBAAS” refers to some cloud platforms that offer options for using a database as a service, without physically launching a virtual machine instance for the database. In the aforementioned configuration, application owners need not install and maintain the database. Instead, the database service provider takes responsibility for installing and maintaining the database, and application owners pay in accordance with usage thereby. For example, AMAZON WEB SERVICES® provides three database services as part of cloud offering, AMAZON SIMPLEDB™, a NoSQL key-value store, Amazon Relational Database Service, a SQL-based database service with a MYSQL® interface, and DYNAMODB®. Similarly, MICROSOFT® offers the SQL AZURE™ Database service as part of cloud offering.

The term “Software-As-A-Service or SAAS” is considered to be part of the nomenclature of cloud computing, along with Infrastructure-As-A-Service (IAAS), Platform-As-A-Service (PAAS), Desktop-As-A-Service (DAAS), Backend-As-A-Service (BAAS), and Information Technology Management-As-A-Service (ITMAAS).

In some scenarios, the SAAS-based app, for instance the SAAS-based app store (or online SAAS-based app store) comprising the secure proprietary client-server SOALNAMSBAAS modular web application software 128, referred to as an On-Demand or cloud-based software may be priced on a pay-per-use basis. In some scenarios, the SAAS providers may price SAAS-based applications, for instance the SAAS-based app store comprising the secure proprietary client-server SOALNAMSBAAS modular web application software 128, using a periodic subscription fee, for instance at least one of an annual, a bi-annual, quarterly and monthly. In some scenarios involving the deployment and implementation of the SAAS-based subscription business model, the cloud providers may install and operate apps, for instance the SAAS-based app store comprising the secure proprietary client-server SOALNAMSBAAS modular web application software 128, in the cloud, for instance the cloud server, for instance the cloud information broker server 102A capable of serving as a broker AAA server, and cloud users may access the apps, for instance the SAAS-based app store comprising the secure proprietary client-server SOALNAMSBAAS modular web application software 128, from the cloud clients, for instance the at least one of autonomous and partially user-operated, at least one of fixed, portable and wearable computing and communications devices belonging to the location information provider client and location information consumer client groups serving as the target and tracker-cum-navigator devices 104A-B, in that order, of FIG. 1. In such scenarios, the cloud users 104A-B may not be required manage the cloud infrastructure and platform, wherein the apps run, thereby facilitating elimination of the need to install and run the apps on the cloud clients, in turn facilitating simplification of maintenance and support. In some scenarios, the pricing model for the SAAS-based apps may be at least one of monthly and yearly flat fee per user, thereby facilitating scalability in terms of price and adjustability in terms of at least one of insertion and deletion of the users.

In some embodiments involving the deployment and implementation of the SAAS-based subscription business models, the SAAS-based app store manifests in the form of at least one of an On-Demand and a cloud-based app store. In use, the installation and updation of the apps is managed through the cloud-based app store.

In some embodiments, implementation of the cloud information broker server as a standard service accessible over the web with predefined Application Programming Interfaces (APIs) to at least one of accept and reply to at least one of an information and location request is disclosed, in accordance with the principles of the present invention. In operation, one or more predefined routes may be created using a different set of APIs for the web service, which only AAA users have access to.

In some practical embodiments, at least one of adaptive, dynamic configuration and a combination thereof, of the User Experience (UX) using the tracker devices, for example the at least one of application domain-, technology- and platform-agnostic tracker-cum-navigator are disclosed, in accordance with the principles of the present invention.

With reference to FIG. 1, the tracker-cum-navigator 104B may facilitate at least one of target detection and tracking, for instance at least one of target tracking by detection and target detection by tracking, of the target devices 104A at least one of in transit, en-route and in standstill mode and supplying a timely ordered sequence of respective location data to a model e.g. capable to serve for depicting the motion on a display capability.

In some embodiments, design and implementation of the secure proprietary client-server SOALNAMSBAAS modular web application software that is at least one of platform-independent, platform-agnostic and cross-platform compatible is disclosed, in accordance with the principles of the present invention. For example, and in no way limiting the scope of the invention, the secure proprietary client-server SOALNAMSBAAS modular web application software may be developed to be deployed and implemented across multiple mobile Operating Systems (or mobile OSs), namely ANDROID™, IOS®, WINDOWS®, BB™, and the like. In some embodiments, by virtue of the property of at least one of “platform independence,” “cross-platform compatibility” and “multi-platform compatibility”, the secure proprietary client-server SOALNAMSBAAS modular web application software may directly run on any platform without special preparation or may inter-operate on multiple computer platforms, wherein secure proprietary client-server SOALNAMSBAAS modular web application software may be written in an interpreted language or pre-compiled portable bytecode for which the interpreters or run-time packages may be common or standard components of all platforms.

In some embodiments, the cross-platform proprietary app, for instance the secure proprietary client-server SOALNAMSBAAS modular web application software, may be divided into two types. In some scenarios, individual building or compilation is required for each platform that the secure proprietary client-server SOALNAMSBAAS modular web application software may be capable of supporting. However, in some scenarios, the secure proprietary client-server SOALNAMSBAAS modular web application software may be capable of directly running on any platform without special preparation, for instance the secure proprietary client-server SOALNAMSBAAS modular web application software may be written in an interpreted language or pre-compiled portable byte code for which the interpreters or run-time packages are common or standard components of all platforms. For example, a cross-platform application runs on MICROSOFT WINDOWS®, LINUX® on the x86 architecture and Mac OS X or OS X® on either the POWERPC® or x86 based APPLE® MACINTOSH® systems. In some scenarios, the cross-platform secure proprietary client-server SOALNAMSBAAS modular web application software may run on as many as all existing platforms, or on as few as two platforms.

In some scenarios, at least one of administrators and users of the at least one of autonomous and partially manually-operated, at least one of smart and regular, at least one of fixed, portable and wearable computing and communications devices belonging to the location information consumer and location information provider client groups and correspondingly serving as the target devices 104A and tracker-cum-navigator devices 104B, in that order, may be required or requested to download the client-side of the secure proprietary client-server SOALNAMSBAAS modular web application software 128, of FIG. 1, from at least one of a Direct Download Link (DDL) supplied on the aforementioned devices 104A-B via clicking the DDL and the client-side app store on the devices 104A and 104B belonging to the location information consumer client and location information provider client and correspondingly serving as the target devices 104A and tracker-cum-navigator devices 104B, in that order, via searching for the client-side of the secure proprietary client-server SOALNAMSBAAS modular web application software using a browser, for instance a mobile browser.

In some operational embodiments, the tracker-cum-navigator devices 104B may facilitate at least one of adaptive, dynamic configuration, and a combination thereof, of the User Experience (UX), in accordance with the principles of the present invention.

In some practical embodiments, at least one of adaptive, dynamic configuration and a combination thereof, of the User Experience (UX) using the tracker devices, for example the at least one of application domain-, technology- and platform-agnostic tracker and navigator comprising the information consuming cloud clients, for instance of the at least one of fully and partially autonomously operable, at least one of embedded and general portable and wearable computing and communications devices belonging to both the information consumer client group are disclosed, in accordance with the principles of the present invention.

In some operational embodiments involving generation of at least one of configurable contextual, context-based, context-dependent, context-sensitive and context-aware notifications, the at least one of autonomous and partially manually-operated, at least one of smart and regular, at least one of 1) embedded and 2) at least one general-purpose fixed, portable and wearable computing and communications devices belonging to the cloud information consumer client group serving or posing as the tracker-cum-navigator devices 104B in the context of deployment of the present system 100, may facilitate generation of the notifications based on Estimated Time of Arrival or ETA (sometimes called ETOA) approximation, in accordance with the principles of the present invention.

Further, in some operational embodiments involving generation of at least one of configurable contextual, context-based, context-dependent, context-sensitive and context-aware notifications, the at least one of autonomous and manually-operated, at least one of smart and regular, at least one of 1) embedded and 2) at least one general-purpose fixed, portable and wearable computing and communications devices belonging to the cloud information consumer client group serving or posing as the tracker-cum-navigator devices 104B in the context of deployment of the present system 100, may facilitate generation of the notifications based on relative checkpoint, for instance for a pre-defined route with configured checkpoints, in accordance with the principles of the present invention.

Still further, in some operational embodiments involving generation of at least one of configurable contextual, context-based, context-dependent, context-sensitive and context-aware notifications, the at least one of autonomous and manually-operated, at least one of smart and regular, at least one of 1) embedded and 2) at least one general-purpose fixed, portable and wearable computing and communications devices belonging to the cloud information consumer client group serving or posing as the tracker-cum-navigator devices 104B in the context of deployment of the present system 100, may facilitate generation of the notifications based on proximity of the moving target devices 104A vis-à-vis one or more of at least one of given (predefined or implicit) checkpoints, reference points, target locations, and explicit user-defined reference points, for instance the at least one of autonomous and partially manually-operated, at least one of smart and regular, at least one of 1) embedded and 2) at least one general-purpose fixed, portable and wearable computing and communications devices belonging to the cloud information provider client group serving as the target devices 104A, in accordance with the principles of the present invention.

In some operational embodiments involving generation of at least one of configurable contextual, context-based, context-dependent, context-sensitive and context-aware alerts, the at least one of autonomous and partially manually-operated, at least one of smart and regular, at least one of 1) embedded and 2) at least one general-purpose fixed, portable and wearable computing and communications devices belonging to the cloud information consumer client group serving or posing as the tracker-cum-navigators devices 104B in the context of deployment of the present system 100, may facilitate generation of the alerts based on detours from one or more pre-defined routes, in accordance with the principles of the present invention. In some potential embodiments, the at least one of autonomous and partially manually-operated, at least one of smart and regular, at least one of 1) embedded and 2) at least one general-purpose fixed, portable and wearable computing and communications devices belonging to the cloud information consumer client group serving as the tracker-cum-navigator devices 104B may facilitate capturing the contextual information in connection with detour, analyzing the captured contextual information in connection with detour, profiling the contextual information in connection with detour based on the results of analyses, categorizing the contextual information in connection with detour based on the generated profiles, recommending one or more at least one of most-optimal adaptively-defined, dynamically-defined and pre-defined detour routes, and tracking efficacy of the recommendations made, in accordance with the principles of the present invention.

Further, in some operational embodiments involving generation of at least one of configurable contextual, context-based, context-dependent, context-sensitive and context-aware alerts, the at least one of autonomous and partially manually-operated, at least one of smart and regular, at least one of 1) embedded and 2) at least one general-purpose fixed, portable and wearable computing and communications devices belonging to the cloud information consumer client group serving as the tracker-cum-navigator devices 104B, may facilitate generation of the alerts based on at least one of deferred and extended stop time vis-à-vis at least one of expected, guesstimated, desired and actual defined stop time at a given checkpoint, in accordance with the principles of the present invention.

Still further, in some operational embodiments involving generation of at least one of configurable contextual, context-based, context-dependent, context-sensitive and context-aware alerts, the at least one of autonomous and partially manually-operated, at least one of smart and regular, at least one of 1) embedded and 2) at least one general-purpose fixed, portable and wearable computing and communications devices belonging to the cloud information consumer client group serving as the tracker-cum-navigator devices 104B, may facilitate generation of the alerts based on the one or more quantified qualitative ranking indices for, or of, at least one of zones, regions, areas, localities, streets and lanes, as well as routes at least one of emanating therefrom and terminating thereto, for instance a crowd-sourced safety index, whilst at least one of generating a route, in transit and en- route, in accordance with the principles of the present invention.

In some operational embodiments, the at least one of autonomous and manually-operated, at least one of smart and regular, at least one of 1) embedded and 2) at least one general-purpose fixed, portable and wearable computing and communications devices belonging to the cloud information consumer client group serving or posing as the tracker-cum-navigator devices 104B, may at least one of automatically and autonomously turn-off, upon fulfillment of at least one of a given (pre-defined) and explicit user-defined tracking objective.

In some real-time use case scenarios, the at least one of autonomous and partially manually-operated, at least one of smart and regular, at least one of 1) embedded and 2) at least one general-purpose fixed, portable and wearable computing and communications devices belonging to the cloud information provider client group serving or posing as the target devices 104A, when subjected to tracking by the tracker-cum-navigator devices 104B, may be installed in public vehicles. In such scenarios, in operation, the at least one of authorizers, in-charge and drivers of the public vehicles may configure the target devices 104A so as to render one or more services, namely 1) defining one or more routes with one or more checkpoints; and 2) defining one or more lists comprising selectively compiling the one or more tracker-cum-navigator devices 104B at least one of adaptively, dynamically approved, and a combination thereof, by the one or more target devices 104A, thereby facilitating allowing the tracker-cum-navigator devices 104B Authenticated, Authorized and Accounted (AAA) access and control to the contextual and locational information associated with the target devices 104A, based on selection by the process of elimination subject to at least one of adaptively-, dynamically-, pre-defined (or statically) defined, and a combination thereof, criteria, in accordance with the principles of the present invention.

Further, in use, a given public vehicle may commence journey on a given route at least one of adaptively, dynamically, statically defined, and a combination thereof, by the target device 104A installed therein. Still further, in use, a given user or passenger or commuter may be desirous of boarding or embarking the public vehicle at a given checkpoint, for instance at the Eighth (8^{th}) checkpoint of a total of Ten (10) checkpoints, defined on the given route. In use, in addition to tracking the public vehicle at least one of live en-route and in transit using at least one of mapping application and grid references installed and running on the tracker 104B owned and operated by the user, the user may at least one of adaptively, dynamically generate, and combination thereof, at least one of contextual, context-based, context-dependent, context-sensitive and context-aware notifications for target 104A installed in the public vehicle, and manage the generated notifications via at least one of reconfiguring and re-contextualizing the same based on at least one of ETA approximation, relative checkpoint, for instance upon arrival of the public vehicle at a given checkpoint of the total of 10 checkpoints, and proximity of the target 104A, in accordance with the principles of the present invention.

In some real-time use case scenarios involving live-tracking, at least one of a friend, colleague, family member and social media contact may hire at least one of a public vehicle, for instance cab or taxi, and driver for a long-distance journey, for instance more than approximately Two (2) hours. Upon commencement of the journey, the at least one of autonomous and manually-operated, at least one of smart and regular, at least one of 1) embedded and 2) at least one general fixed, portable and wearable computing and communications device belonging to the information provider client group 104A, owned and operated by the at least one of friend, colleague, family member and social media contact, may serve to function as a target 104A. Further, the at least one of friend, colleague, family member and social media contact may grant permission to the at least one of autonomous and manually-operated, at least one of smart and regular, at least one of 1) embedded and 2) at least one general fixed, portable and wearable computing and communications device belonging to the information consumer client group 104B, owned and operated by at least one of another friend, peer, family member and social media contact, serving as a tracker 104B, which permitted or target-approved tracker 104B may be at least one of inserted and populated into a list of target-approved trackers 104B in the broker 102A. Still further, upon grant of permission, the target 104A may at least one of adaptively, dynamically, statically define, and a combination thereof, at least one of preferred, available and recommended route for the long-distance journey using, or with, the information broker server 102A. In some scenarios involving non-live tracking of the target 104A, the user of the tracker 104B may at least one of adaptively, dynamically generate, and combination thereof, at least one of contextual, context-based, context-dependent, context-sensitive and context-aware alerts for target 104A at least one of installed in the public vehicle and owned or operated by the user of the target 104A, and manage the generated alerts via at least one of reconfiguring and re-contextualizing the same based on at least one of 1) detours of the target 104A from the one or more pre-defined routes, 2) at least one of deferred and extended stop time of the target 104A, and 3) the one or more quantified qualitative ranking indices for, or of, at least one of zones, regions, areas, localities, streets and lanes, as well as routes at least one of emanating therefrom and terminating thereto. In some specific scenarios involving tracking of the target 104A by the tracker 104B via at least one of adaptive, dynamic generation, and combination thereof, of at least one of contextual, context-based, context-dependent, context-sensitive and context-aware alerts for target 104A installed in the public vehicle, the tracker 1046 may manage the generated alerts via at least one of reconfiguring and re-contextualizing the same.

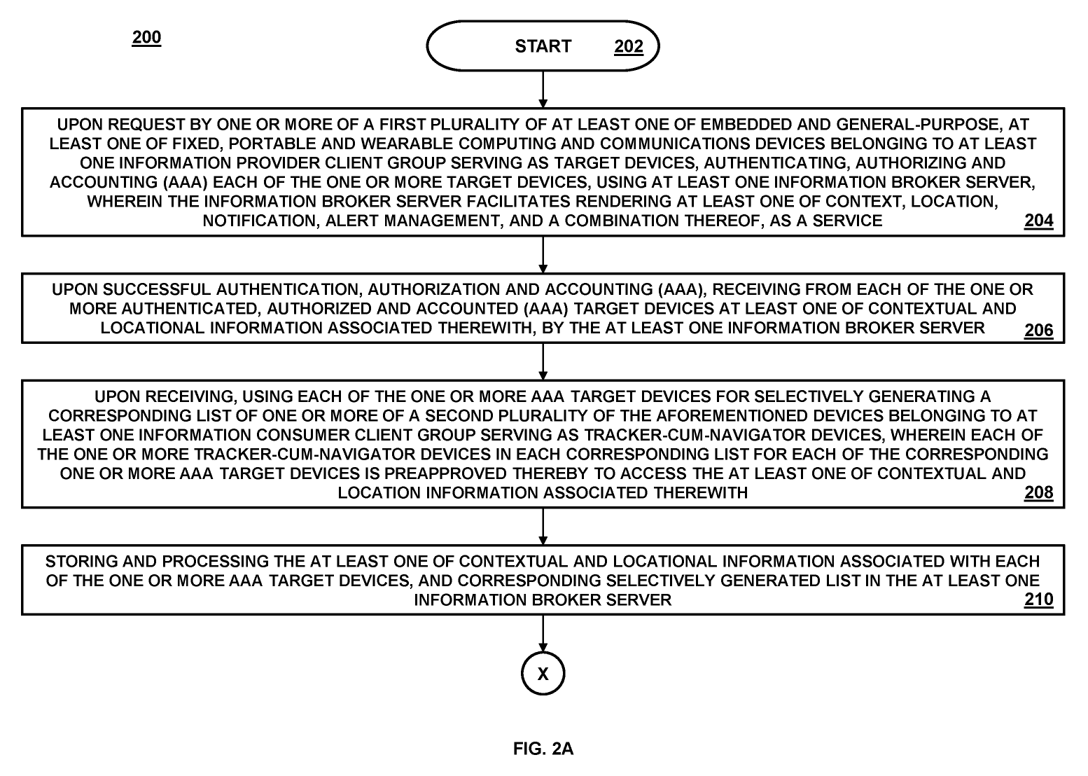

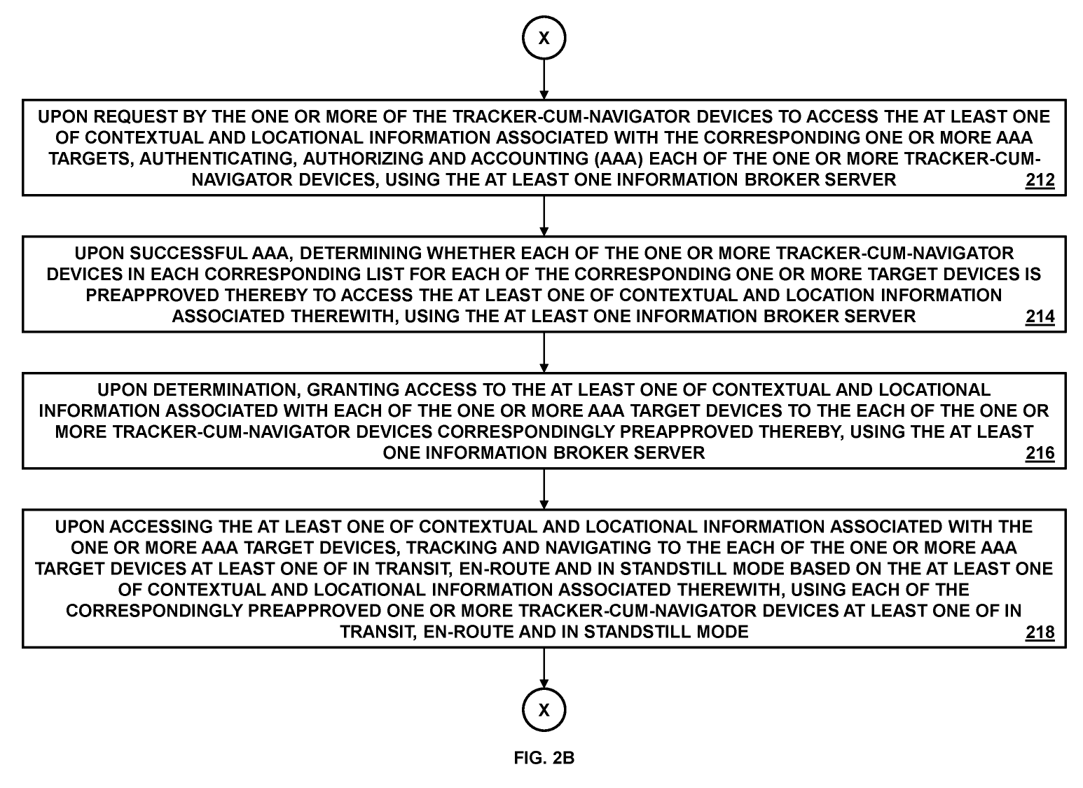

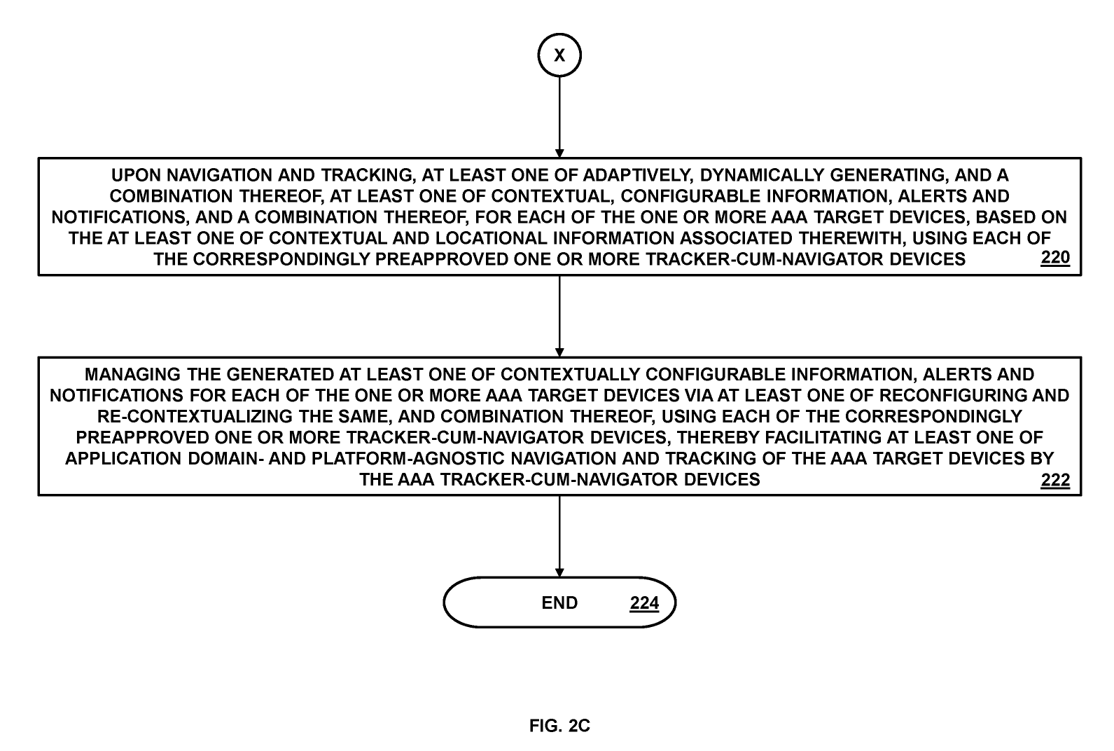

FIGS. 2A-C depicts a method for managing navigation and tracking of at least one of embedded and general-purpose, at least one of fixed, portable and wearable, computing and communications devices, according to one or more embodiments.

The method 200 starts at step 202 and proceeds to step 204.

At step 204, the method 200 may comprise, or facilitate, upon request by one or more of a first plurality of at least one of embedded and general-purpose, at least one of fixed, portable and wearable computing and communications devices belonging to at least one information provider client group serving as the target devices, for instance the target devices 104A, of FIG. 1, Authenticating, Authorizing and Accounting (AAA) each of the one or more target devices 104A, using at least one information broker server, for instance the information broker server 102A, of FIG. 1, wherein the information broker server 102A may facilitate rendering at least one of location, information, notification, alert management, and a combination thereof, as a service.

At step 206, the method 200 may comprise, or facilitate, upon successful AAA, receiving from each of the one or more AAA target devices 104A at least one of contextual and locational information associated therewith, by the at least one information broker server 102A.

At step 208, the method 200 may comprise, or facilitate, upon receiving, using each of the one or more AAA target devices 104A for selectively generating a corresponding list therefor comprising one or more of a second plurality of the aforementioned devices belonging to at least one information consumer client group serving as tracker-cum-navigator devices, for instance the tracker-cum-navigator devices 104B, of FIG. 1, wherein each of the one or more tracker-cum-navigator devices 104B in each corresponding list for each of the corresponding one or more AAA target devices 104A is preapproved thereby to access the at least one of contextual and location information associated therewith.

At step 210, the method 200 may comprise, or facilitate, storing and processing the at least one of contextual and locational information associated with each of the one or more AAA target devices 104A, and corresponding selectively generated list in the at least one information broker server 102A.

At step 212, the method 200 may comprise, or facilitate, upon request by the one or more of the tracker-cum-navigator devices 104B to access the at least one of contextual and locational information associated with the corresponding one or more AAA target devices 104A, Authenticating, Authorizing and Accounting (AAA) each of the one or more tracker-cum-navigator devices 104B, using the at least one information broker server 102A.

At step 214, the method 200 may comprise, or facilitate, upon successful AAA, determining whether each of the one or more AAA tracker-cum-navigator devices 104B in each corresponding list for each of the corresponding one or more AAA target devices 104A is preapproved thereby to access the at least one of contextual and location information associated therewith, using the at least one information broker server 102A.

At step 216, the method 200 may comprise, or facilitate, upon determination, granting access to the at least one of contextual and locational information associated with each of the one or more AAA target devices 104A to the each of the one or more AAA tracker-cum-navigator devices 104B correspondingly preapproved thereby, using the at least one information broker server 102A.

At step 218, the method 200 may comprise, or facilitate, upon accessing the at least one of contextual and locational information associated with the one or more AAA target devices 104A, tracking and navigating to the each of the one or more AAA target devices 104A at least one of in transit, en-route and in standstill mode based on the at least one of contextual and locational information associated therewith, using at least one of each of the correspondingly preapproved one or more tracker-cum-navigator devices 104B at least one of in transit, en-route and in standstill mode.

At step 220, the method 200 may comprise, or facilitate, upon navigation and tracking, at least one of adaptively, dynamically generating, and a combination thereof, at least one of contextual, configurable information, alerts and notifications, and a combination thereof, for, or in connection with, each of the one or more AAA target devices 104A, based on the at least one of contextual and locational information associated therewith, using each of the correspondingly preapproved one or more tracker-cum-navigator devices 104B.

At step 222, the method 200 may comprise, or facilitate, managing the generated at least one of contextually configurable information, alerts and notifications for each of the one or more AAA target devices 104A via at least one of reconfiguring and re-contextualizing the same, and combination thereof, using each of the correspondingly preapproved one or more tracker-cum-navigator devices 104B, thereby facilitating at least one of application domain- and platform-agnostic navigation and tracking of the AAA target devices 104A by the AAA tracker-cum-navigator devices 104B.

The method 200 ends at step 224.

In some advantageous embodiments, the present system facilitates providing a multipurpose solution to problems owing to at least one of gaps, loopholes and whitespaces identified in the prior art, wherein there is a likelihood of design and implementation of at least one of new and enhanced methods, apparatuses and systems for managing navigation and tracking of portable computing and communications devices, in accordance with the principles of the present invention. In some advantageous scenarios, the present system facilitating the tracker-cum-navigator devices in implementing the method for at least one of adaptively, dynamically generating, and combination thereof, at least one of contextual, context-based, context-dependent, context-sensitive and context-aware alerts, and notifications, for the target devices, and managing the generated alerts and notifications via at least one of reconfiguring and re-contextualizing the same, and combination thereof, may, in turn, facilitate the tracker-cum-navigator devices in maintaining accurate Real-Time (RT) awareness as to the whereabouts of the target devices at least one in transit, en-route and in standstill mode, whilst avoiding interrupting the target devices via directly communicating therewith. For example, and in no way limiting the scope of the invention, both the target and tracker-cum-navigator devices may be at least one of a person owing the at least one of smart and retrofit smart, at least one of embedded and general, portable and wearable computing and communications device at least one of fully autonomously and partially manually operable and a physical entity with the at least one of fully autonomously and partially manually operable, at least one of smart and retrofit smart, at least one of embedded and general, portable and wearable computing and communications device installed therein.

In some advantageous scenarios, the present system, and methods implemented thereby may facilitate planning at least one of pickup, drop and rendezvous, whereby the waiting period may be at least one of zeroized and minimized owing to at least one of adaptive, dynamic (timely or in time or Just-In-Time (JIT)) generation, and a combination thereof, of at least one of contextual, context-based, context-dependent, context-sensitive and context-aware notifications, by the tracker-cum-navigator devices for the target devices, for instance, and managing the generated alerts and notifications via at least one of reconfiguring, re-contextualizing the same, and a combination thereof, in accordance with the principles of the present invention.

In some advantageous scenarios, the present system, and methods implemented thereby may facilitate at least one adaptive, dynamic Real-Time (RT) and Near Real-Time (NRT) location sharing, and a combination thereof, based on one or more quantified qualitative ranking indices for, or of, at least one of current zones, regions, areas, localities, streets and lanes, as well as routes at least one of emanating therefrom and terminating thereto, for instance at least one of crowd-sourced safety index and matrix, thereby facilitating providing frequent updates in potentially unsafe locations, wherein the likelihood of occurrence of at least one of known, unknown, expected, unexpected, natural, unnatural, wanted, unwanted, just, unjust, timely and untimely situations eventuating anytime and anyhow is high, whereas providing relatively less frequent updates in potentially safe locations, in turn, facilitating managing an optimal trade-off between the updates delivered and power consumed, in accordance with the principles of the present invention.

In some advantageous scenarios, the present system, and methods implemented thereby may facilitate at least one of domain-, technology- and platform-agnostic tracking and navigation, thereby facilitating fast and easy adaptability in at least one of information and location sharing in one or more application based real-time use-case scenarios, for instance school transportation, cab services, courier services, public transportation, personal tracking etc., in accordance with the principles of the present invention.

In some advantageous scenarios, the present system, and methods implemented thereby may facilitate a single and consistent end user experience (UX) for various location consumption scenarios, in accordance with the principles of the present invention.

In some advantageous scenarios, the present system, and methods implemented thereby may facilitate deployment of a crowdsourced location safety matrix and populating the same by the senior users, in turn, facilitating peer (or junior) users in at least one of generating and defining safe routes between any pair of identified and selected source and destination locations and feeding the updated safety matrix back to hosting authorities for corrective actions whenever and wherever needed, if any, in accordance with the principles of the present invention.

In some advantageous scenarios, the present system, and methods implemented thereby may facilitate the at least one of mobile, itinerant, in transit, en-route, sedentary and stationery trackers in at least one of adaptively, dynamically generating, and a combination thereof, at least one of contextual, context-based, context-dependent, context-sensitive and context-aware information, alerts, and notifications, for the at least one of mobile, itinerant, in transit, en-route, sedentary and stationery target devices, and managing the generated information, alerts and notifications via at least one of reconfiguring and re-contextualizing the same, and combination thereof, thereby facilitating at least one of contextual, context-based, context-dependent, context-sensitive and context-aware tracking and navigation of the target devices, in accordance with the principles of the present invention.

In some advantageous embodiments, mutually or collaboratively controlled many-to-one unidirectional interactive navigation and tracking of one or more entities belonging to one or more shared explicit user-defined groups using the tracker-cum-navigator and target devices in the context of deployment of the present system is disclosed, in accordance with the principles of the present invention. For example, and in no way limiting the scope of the invention, the one or more entities may comprise one or more given vehicles, the corresponding at least one of owners and drivers therefor, at least one of the target and tracker-cum-navigator devices at least one of fixedly installed and portably manually operated therein by the at least one of owners and drivers therefor, whereas the shared explicit user-defined group may be a given group of at least one of friends, colleagues, family members and social media contacts at least one of owing and driving the vehicles. In some scenarios involving a given group of friends at least one of planning and travelling to a given common destination location, deployment of the present system may facilitate the tracker-cum-navigator devices in implementing the method for managing navigation and tracking of the target devices comprising at least one of adaptively, dynamically generating, and a combination thereof, configurable contextual, context-based, context-dependent, context-sensitive, context-aware information, alerts, as well as notifications, in connection with the target devices, and managing the generated information, alerts and notifications via at least one of reconfiguring, re-contextualizing the same, and combination thereof, in accordance with the principles of the present invention. In some scenarios, at least one vehicle may be mutually declared amidst the given group of friends to lead the tour to the given common destination location, and which lead vehicle may be also mutually declared as a target vehicle from the standpoint of managing navigation and tracking. Specifically, in use, the target device may be at least one of fixedly installed in the target vehicle and portable operated manually therein. Upon mutual agreement on the target vehicle, the target device may request access to the information broker server for merely sharing a selectively generated list of the of the other tracking vehicles comprising the corresponding tracker-cum-navigator device at least one of fixedly installed in the target vehicle and portable operated manually therein, except the target vehicle, preapproved by the target device in the target vehicle to access at least one of contextual and locational information associated therewith, in accordance with the principles of the present invention. Upon requesting access, the information broker server may subject the target device in the target vehicle to AAA. Upon successful AAA, the AAA target device in the target vehicle may share or transmit the selectively generated list with or to the information broker server. In such scenarios, the target device in the target vehicle may merely configure the information broker server to allow the other tracking vehicles comprising the corresponding tracker-cum-navigator devices for purposes of navigation and tracking of the AAA target vehicle, in accordance with the list, subject to successful AAA of the corresponding tracker-cum-navigator devices in the other tracking vehicles by the information broker server. Upon successful AAA, the information broker server may determine whether the corresponding tracker-cum-navigator devices in the other AAA tracking vehicles have been preapproved by the AAA target vehicle to access the at least one of contextual and locational information associated therewith, based on the list. Upon allowance, the corresponding tracker-cum-navigator devices in the other AAA tracking vehicles may initiate or commence navigation and tracking of the AAA target vehicle, and thus follow the same to the given common destination location. In such scenarios, the corresponding tracker-cum-navigator devices in the other AAA tracking vehicles may at least one of adaptively, dynamically generate, and combination thereof, configurable contextual, context-based, context-dependent, context-sensitive, context-aware information, alerts, as well as notifications, in connection with the target device in the AAA target vehicle, and manage the generated information, alerts and notifications via at least one of reconfiguring, re-contextualizing the same, in accordance with the principles of the present invention. Specifically, in use, in some scenarios, the corresponding tracker-cum-navigator devices in the other AAA tracking vehicles may configure the contextual notifications based on the proximity of the target device in the AAA target vehicle at least one of in transit, en-route and in standstill mode based on at least one of the distance and time of proximity between the AAA target vehicle vis-à-vis the other AAA tracking vehicles, in accordance with the principles of the present invention. Upon completion of the journey or tour, at least one of the target device in the AAA target vehicle, the tracker-cum-navigator devices in the other AAA tracking vehicles, and a combination thereof, may provide a safety index for the route opted, traversed and tracked based on the mutual exposure and experience of both the target device in the AAA target vehicle and the tracker-cum-navigator devices in the other AAA tracking vehicles. In some alternative scenarios, the at least one of the target device in the AAA target vehicle, the tracker-cum-navigator devices, and a combination thereof, may provide a safety index for one or more user-selected checkpoints in the route opted, traversed and tracked based on the mutual exposure and experience of both the target device in the AAA target vehicle and the tracker-cum-navigator devices in the other AAA tracking vehicles. In some embodiments, one or more other target devices and tracker-cum-navigator devices may be able to access, retrieve and view the safety indices at later period in time, wherein the foregoing facilities may be availed by the one or more other target devices and tracker-cum-navigator devices as subscribers to subscription-based licensing and deliver of Safety-As-A-Service (SAAS) under SAAS-based subscription business model, in accordance with the principles of the present invention.

### Example Computer System

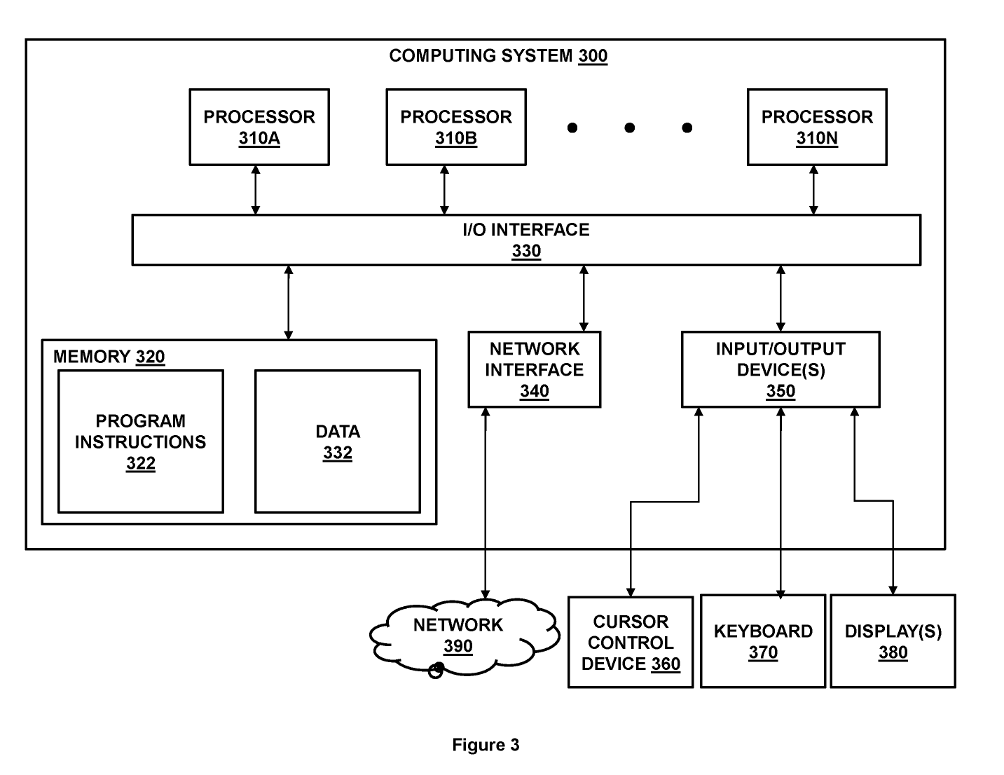

FIG. 3 depicts a computer system that may be a computing device and may be utilized in various embodiments of the present invention.

Various embodiments of the advanced method and system for managing navigation and tracking of, for and by portable wearable computing and communications devices, as described herein, may be executed on one or more computer systems, which may interact with various other devices. One such computer system is computer system 300 illustrated by FIG. 3, which may in various embodiments implement any of the elements or functionality illustrated in FIGS. 1-2. In various embodiments, computer system 300 may be configured to implement one or more methods described above. The computer system 300 may be used to implement any other system, device, element, functionality or method of the above-described embodiments. In the illustrated embodiments, computer system 300 may be configured to implement one or more methods as processor-executable executable program instructions 322 (e.g., program instructions executable by processor(s) 310A-N) in various embodiments.

In the illustrated embodiment, computer system 300 includes one or more processors 310A-N coupled to a system memory 320 via an input/output (I/O) interface 330. The computer system 300 further includes a network interface 340 coupled to I/O interface 330, and one or more input/output devices 350, such as cursor control device 360, keyboard 370, and display(s) 380. In various embodiments, any of components may be utilized by the system to receive user input described above. In various embodiments, a user interface (e.g., user interface) may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310A-N may be any suitable processor capable of executing instructions. For example, in various embodiments processors 310 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 310A-N may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350. In some embodiments, I/O interface 330 may perform any necessary protocol, timing or other data transformations to convert data signals from one components (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 350 may, in some embodiments, include one or more display terminals, keyboards, keypads, touchpads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for at least one of application domain- and platform-agnostically managing navigation and tracking of, for and by at least one of embedded and general-purpose, at least one of fixed, portable and wearable, computing and communications devices, the method comprising:
upon request by one or more of a first plurality of the at least one of embedded and general-purpose, at least one of fixed, portable and wearable computing and communications devices belonging to at least one information provider client group serving as target devices, Authenticating, Authorizing and Accounting (AAA) each of the one or more target devices, using at least one information broker server, wherein the information broker server facilitates rendering at least one of context, location, safety, security, notification, alert management, and a combination thereof, as a service;
upon successful Authentication, Authorization and Accounting (AAA), receiving from each of the one or more Authenticated, Authorized and Accounted (AAA) target devices at least one of contextual and locational information associated therewith, by the at least one information broker server;
upon receiving, using each of the one or more AAA target devices for selectively generating a corresponding list of one or more of a second plurality of the aforementioned devices belonging to at least one information consumer client group serving as tracker-cum-navigator devices, wherein each of the one or more tracker-cum-navigator devices in each corresponding list for each of the corresponding one or more AAA target devices is preapproved thereby to access the at least one of contextual and location information associated therewith;
storing and processing the at least one of contextual and locational information associated with each of the one or more AAA target devices, and corresponding selectively generated list in the at least one information broker server;
upon request by the one or more of the tracker-cum-navigator devices to access the at least one of contextual and locational information associated with the corresponding one or more AAA targets, Authenticating, Authorizing and Accounting (AAA) each of the one or more tracker-cum-navigator devices, using the at least one information broker server;
upon successful AAA, determining whether each of the one or more tracker-cum-navigator devices in each corresponding list for each of the corresponding one or more target devices is preapproved thereby to access the at least one of contextual and location information associated therewith, using the at least one information broker server;
upon determination, granting access to the at least one of contextual and locational information associated with each of the one or more AAA target devices to the each of the one or more tracker-cum-navigator devices correspondingly preapproved thereby, using the at least one information broker server;
upon accessing the at least one of contextual and locational information associated with the one or more AAA target devices, tracking and navigating to the each of the one or more AAA target devices at least one of in transit, en-route and in standstill mode based on the at least one of contextual and locational information associated therewith, using each of the correspondingly preapproved one or more tracker-cum-navigator devices at least one of in transit, en-route and in standstill mode;
upon navigation and tracking, at least one of adaptively, dynamically generating, and a combination thereof, at least one of contextualizable, configurable, information, alerts and notifications, and a combination thereof, for each of the one or more AAA target devices, based on the at least one of contextual and locational information associated therewith, using each of the correspondingly preapproved one or more tracker-cum-navigator devices; and
managing the generated at least one of contextually configurable information, alerts and notifications for each of the one or more AAA target devices via at least one of reconfiguring and re-contextualizing the same, and combination thereof, using each of the correspondingly preapproved one or more tracker-cum-navigator devices, thereby facilitating at least one of application domain-, technology- and platform-agnostic navigation and tracking of the AAA target devices by the AAA tracker-cum-navigator devices.

2. The method of claim 1, wherein the at least one information broker server additionally facilitates subscription-based licensing and delivery of at least one of Authentication, Authorization and Accounting (AAA), context-based, context-aware, context-sensitive, context-dependent, location-based, location-aware, location-sensitive, location-dependent services, and one or more combinations thereof, as a service to the one or more Authenticated, Authorized and Accounted (AAA) target and tracker-cum-navigator devices under a subscription business model against payment of a periodic subscription fee.

3. The method of claim 1, wherein the tracker-cum-navigator devices facilitate generating at least one of use-specific contextual, user-contextualized, user-configured notifications, and a combination thereof, in connection with the target devices at least one of in transit and en-route based on Estimated Time of Arrival (ETA) approximation comprising at least one of contextualizing, configuring the notifications, and a combination thereof, for example contextually configuring, based on at least one of i) the context associated with the target devices, ii) dependence thereof, i.e. context-dependence, iii) dependency thereof, i.e. context-dependency, iv) sensitivity thereto, i.e. context-sensitivity and iv) awareness thereof, i.e. context-awareness, and managing the generated notifications via at least one of re-contextualizing, reconfiguring the same, and a combination thereof.

4. The method of claim 3, wherein the tracker-cum-navigator devices facilitate generating at least one of configurable, contextualizable, contextual, context-based, context-dependent, context-sensitive and context-aware notifications based on one or more relative checkpoints in at least one of adaptively-, dynamically- and pre-defined routes comprising one or more of at least one of adaptively-, dynamically- and pre-defined checkpoints, and wherein the at least one of adaptively-, dynamically- and pre-defined routes are at least one of explicit user-defined and implicit routes, whereas the at least one of adaptively-, dynamically- and pre-defined checkpoints are at least one of explicit user-defined and implicit checkpoints.

5. The method of claim 4, wherein the tracker-cum-navigator devices facilitate generating at least one of configurable, contextualizable, contextual, context-based, context-dependent, context-sensitive and context-aware notifications based on the proximity of the one or more tracker-cum-navigator devices vis-à-vis the one or more target devices, wherein the proximity of the target devices vis-à-vis the tracker-cum-navigator devices is configurable based on at least one of the distance, time of proximity therebetween, checkpoints and locations of the target devices.

6. The method of claim 5, wherein the tracker-cum-navigator devices facilitate generating at least one of configurable contextual, context-based, context-dependent, context-sensitive and context-aware information and alerts based on detours from one or more pre-defined routes.

7. The method of claim 6, wherein the tracker-cum-navigator devices facilitate generating at least one of configurable contextual, context-based, context-dependent, context-sensitive and context-aware information and alerts based on at least one of deferred and extended stop time vis-à-vis at least one of expected, guesstimated, desired and actual defined stop time at a given pre-defined checkpoint.

8. The method of claim 6, wherein the tracker-cum-navigator devices facilitate generating at least one of configurable contextual, context-based, context-dependent, context-sensitive and context-aware information and alerts based on the one or more quantified qualitative ranking indices for, or of, at least one of zones, regions, areas, localities, streets and lanes, as well as routes at least one of emanating therefrom and terminating thereto.

9. The method of claim 1, wherein both the target and tracker-cum-navigator devices are at least one of location- and context-aware, as well as context-adaptive, and wherein both the target and tracker-cum-navigator devices are specifically at least one of temporally, spatially, semantically and ambient context-aware.

10. The method of claim 1, wherein the tracker-cum-navigator devices facilitate at least one of adaptively, dynamically managing, and a combination thereof, navigation and tracking of the target devices.

11. The method of claim 1, wherein the tracker-cum-navigator devices facilitate at least one of application domain-, technology- and platform-agnostic navigation and tracking of the tracker devices.

12. The method of claim 1, wherein at least in some scenarios each of one or more explicit user-defined tourist groups destined to a given common destination comprising at least a mutually agreed target vehicle and tracker-cum-navigator vehicle correspondingly owned by at least a mutually agreed tour leader and tour follower may be subjected to at least one of mutually and collaboratively controlled, many-to-one, unidirectional interactive navigation and tracking of the target vehicle using the tracker-cum-navigator vehicle at least one of in transit and en-route, wherein the target and tracker-cum-navigator vehicles correspondingly comprise at least one of a mobile vehicular and handheld client correspondingly serving as at least one of a target and tracker-cum-navigator device and at least one of fixedly removably installed and movably deployed therein, and wherein upon successful Authentication, Authorization and Accounting (AAA) the Authenticated, Authorized and Accounted (AAA) target device merely shares with the information broker server a selectively generated list comprising at least the tracker-cum-navigator vehicle preapproved by the AAA target device to track the same whilst withholding information in connection with a potential route, and checkpoints therein, associated therewith, and wherein upon successful AAA the AAA tracker-cum-navigator device tracks the AAA target device comprising at least one of adaptively, dynamically generating, and combination thereof, configurable contextual, context-based, context-dependent, context-sensitive, context-aware information, alerts, as well as notifications, in connection with the AAA target device such that the generated contextual notifications are configurable based on the proximity of the target vehicle vis-à-vis the tracker-cum-navigator vehicle at least one of in transit, en-route and in standstill mode, wherein the proximity of the target vehicle vis-à-vis the tracker-cum-navigator vehicle is configurable based on at least one of the distance and time of proximity therebetween.
